(19) United States
(12) Patent Application Publication
(10) Pub. No.: US 2026/0118168 A1
(43) Pub. Date: Apr. 30, 2026

(54) AN OSCILLATORY RETINAL CIRCUIT WITH NEAR-ZERO ELECTRICAL POWER CONSUMPTION

(71) Applicant: UNIVERSITY OF SOUTHERN CALIFORNIA, Los Angeles, CA (US)

(72) Inventors: Rehan Rashid KAPADIA, Los Angeles, CA (US); Hyun Uk CHAE, Los Angeles, CA (US); Ragib AHSAN, Los Angeles, CA (US)

(73) Assignee: UNIVERSITY OF SOUTHERN CALIFORNIA, Los Angeles, CA (US)

(21) Appl. No.: 18/866,380

(22) PCT Filed: May 30, 2023
(86) PCT No.: PCT/US2023/023883

§ 371 Date: Nov. 15, 2024

Related U.S. Application Data
(60) Provisional application No. 63/346,846, filed on May 28, 2022.

(51) Int. Cl. G01J 1/44

(52) U.S. Cl. CPC G01J 1/44

(57) ABSTRACT

A silicon-graphene-metal photodetector includes a silicon substrate having a first face and a second face. A patterned metal contact is disposed over the first face of the silicon substrate to form a metal-semiconductor contact. A graphene sheet contacts both the silicon substrate and the patterned metal contact such that to form a graphene-semiconductor contact. A retinal circuit including the silicon-graphene-metal photodetector and an inductive component is also provided.

### CROSS-REFERENCE TO RELATED APPLICATIONS

This application claims the benefit of U.S. provisional application Ser. No. 63/346,846 filed May 28, 2022, the disclosure of which is hereby incorporated in its entirety by reference herein.

### STATEMENT REGARDING FEDERALLY SPONSORED RESEARCH OR DEVELOPMENT

This invention was made with government support under FA9550-21-1-0305 awarded by the Air Force Office of Scientific Research, 2004791 awarded by the National Science Foundation, N00014-21-1-2634 awarded by the Office of Naval Research, and DE-SC0022248 awarded by the US Department of Energy. The government has certain rights in the invention.

### TECHNICAL FIELD

In at least one aspect, the present invention relates to oscillatory retinal circuit with near-zero electrical power consumption.

### BACKGROUND

Biological brains can perform computational tasks at a ˜100,000× efficiency compared to digital computers¹⁻⁶. The spiking nature of the neuron's action potential ensures that energy is used only for a short period of time enabling high computational energy efficiency. A typical biological neuron has a surface area of ˜10 μm², spends ˜10 pJ energy to generate each spike, and operates at a frequency of ˜100 Hz which translates to a power cost of ˜1 nW for biological systems^{3,4,6}. The first set of efforts in emulating biological neurons dates back to 1960s using voltage-controlled negative differential resistance devices^{7,8} paired with inductors to produce relaxation oscillations similar to neuronal spiking behavior⁹⁻¹¹. However, inductor scaling challenges limited the utility of such approaches. Recently, the emergence of current-controlled NDR devices opened a new path towards enabling relaxation oscillations using capacitors and has led to considerable progress in artificial spiking neurons¹²⁻²³. One challenge facing current-controlled NDR devices is the power consumption despite the inherent scalability and small volumes. While Mott memristors achieve the NDR behavior through the metal-insulator phase transition, there have been other approaches to producing NDR such as band to band tunneling, Gunn effect, real-space electron transfer in III-V heterostructures, body biasing of MOSFET, exploiting graphene's unique dispersion relationship near its Dirac point, using trap based recombination processes, redox behavior of molecular junctions, and multiple circuits^{7,8,24-34}. However, many of these NDR effects are voltage controlled and therefore would require an inductive circuit element to generate oscillations.

Beyond device-level innovation, in-sensor computing architectures have been developed to partially mitigate the energy and speed penalties associated with converting information between analog and digital domains³⁵⁻⁴⁷. In typical sensor-based systems using traditional Von Neumann computing architecture, a large volume of unprocessed sensory raw data is first stored in temporary memory and then transmitted to the processing unit. Such an architecture demands high energy consumption, large data storage, high bandwidth and slows down the computation. Therefore, in-sensor and near-sensor computing architectures are becoming increasingly popular where the sensory data is preprocessed, and the salient features are extracted in the analog domain to reduce the redundancy in the data. In-sensor and near-sensor computing architectures have been implemented for auditory^{42,48-53}, olfactory⁵⁰, tactile⁵⁴⁻⁵⁶ and vision^{38,39,41,43-45,47,57} sensors demonstrating different levels of analog processing abilities such as noise suppression, signal enhancement, frequency domain decomposition, event-based processing with spike-coding, and even high-level classifications.

Accordingly, there is a need for improved in-sensor computing devices.

### SUMMARY

In at least one aspect, an oscillator circuit is provided. The oscillator circuit includes a sensor that exhibits negative differential resistance and an inductive component in electrical communication with the sensor. Advantageously, the retinal circuit can operate as an oscillator.

In another aspect, a silicon-graphene-metal photodetector that exhibits negative differential resistance is provided. The silicon-graphene-metal photodetector includes a silicon substrate having a first face and a second face. A patterned metal contact is disposed over the first face of the silicon substrate to form a metal-semiconductor contact. A graphene sheet contacts both the silicon substrate and the patterned metal contact such that to form a graphene-semiconductor contact. Advantageously, the silicon-graphene-metal photodetector is operatable with negative differential resistance.

In another aspect, an oscillatory retinal circuit (ORC) integrates sensing and oscillation, in effect emulating the behavior of the photoreceptors, bipolar cells, and ganglion cells in the eye is provided. Critically, it is shown that the ORC can generate spiking oscillations from the sensory optical input directly, without consuming any electrical power at all. The ORC consists of a photodetector that demonstrates NDR only under illumination and an active inductor using a MOSFET. This combination of an optically activated NDR device and MOSFET can generate action potentials that are tunable in frequency and amplitude as a function of the incident optical power density. The key feature of this circuit is that it is expected to generate voltage spikes with less than 0.5 pW external electrical power consumption whereas the Mott transition-based neurons consume electrical power of ˜10⁸ pW/μm² and the state-of-the-art CMOS neuron consumes ˜100 pW/μm^{2 12,14,17-21,23}. It was further shown through simulations that a cluster of these neurons can be coupled together to form a liquid state machine (LSM), which closely resembles the functionality of a cluster of biological neurons⁵⁸⁻⁶⁰. The simulations show that when optical images are projected to this LSM, the similar neurons fire at the same time for a similar set of images and this property enables this LSM in performing handwritten digits recognition from the MNIST database. In addition, edge detection on projected images from the Berkeley segmentation dataset (BSDS300) with a performance comparable to that of a standard edge detection algorithm such as a Sobel filter was also demonstrated.

In another aspect, an oscillatory retinal circuit (ORC) directly converts optical signals into intensity-dependent voltage spike trains, mimicking the functionality of the biological retina. The circuit consists of a silicon-graphene-metal (SGM) photodetector that exhibits negative differential resistance (NDR) under illumination and an active inductive element implemented by a single MOSFET. During operation, the oscillatory retinal circuit transduces the incident optical power into voltage spikes while consuming less than 0.5 pW of power despite having an area of 0.25 cm². Through detailed device simulation and modeling, it was shown that the device behavior emerges due to multiple voltage tunable minority carrier collection channels, each with distinct voltage dependence. Through experimentally calibrated simulations the oscillatory retinal circuit down to 1 μm² with an optical power threshold for oscillations of 200 fW was predicted. Neuron coupling was experimentally demonstrated, illustrating that collective dynamics can be obtained, a necessity for in-sensor processing. Two examples of in-sensor processing are then demonstrated using calibrated simulations. First a liquid state machine for accurate handwritten digit classification and second in-sensor edge detection.

In another aspect, a computing device is provided. The computing device includes a plurality of kernels. Each kernel includes a plurality of oscillators. Each oscillator includes a negative differential resistance component. A plurality of impedance components couples the oscillators together. Characteristically, each oscillator is associated with portion of an input data set. The computing system also includes a readout system to read an output voltage versus time from each oscillator and perform bandpass filtering operations. Advantageously, the readout system is configured to simultaneously provide a plurality of features for each portion of the input data set.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

For a further understanding of the nature, objects, and advantages of the present disclosure, reference should be made to the following detailed description, read in conjunction with the following drawings, wherein like reference numerals denote like elements and wherein:

FIG. 1a. Perspective view of schematics of a silicon-graphene-metal photodetector.

FIG. 1b. Side cross-section of a silicon-graphene-metal photodetector.

FIG. 1c. Schematic illustrations of a sensing device having one retinal cell.

FIG. 1d. Schematic illustrations of a sensing device having two retinal cells.

FIG. 1e. Schematic illustration of a sensing array.

FIG. 1f. Schematic illustration of a hardware implementation of a sensing device.

FIG. 2a. Schematic of an oscillator equivalent circuit.

FIG. 2b. Schematic of NDR device symbol and equivalent circuit.

FIG. 2c. Symbols of inductor-equivalent circuits can be used in the oscillator of FIG. 2a.

FIG. 2d. Schematic of a kernel that can be used in the computing device.

FIG. 2e. Schematic of a computing device.

FIG. 2f. Schematic showing the frequency spectrum for each oscillator being divided into a plurality of frequency bands.

FIG. 2g. Schematic showing that each frequency band can provide a measurable feature.

FIGS. 3a, 3b, 3c, 3d, 3e, 3f, 3g, 3h, and 3i. ORN enabled by SGM photodetector. (a) Schematic of the SGM photodetector device. (b) I-V curves measured at dark conditions and under uniform illumination (445 nm) in linear and (c) log scale. (d) Schematic of a single unit of ORN. (e) V-t curves measured at different optical intensities and (f) corresponding frequency spectrum. (g) spiking frequency and amplitude as a function of optical intensity. (h) Experimental plot of minimum optical power required for oscillation with neuron area. (i) Calculation of dark current limited and LC limited P_{op,min} for oscillation without external electrical power.

FIGS. 4a, 4b, 4c, 4d, 4e, 4f, and 4g. NDR mechanism and Sentaurus simulations. (a) Schematic of NDR mechanism showing the competing channels for the collection of minority electrons at different voltages. (b) Optical micrograph of the grid in the device showing direction of position dependent measurement. (c) Spatial dependence of current for focused beam measurements at 532 nm wavelength at a power of 12.6 mW. (d) Spatial dependence of peak and valley current and PVCR. (e) Sentaurus simulations showing the effect of charge traps and (e,f) carrier lifetime in determining NDR behavior for a trap density of 10¹² cm⁻². (g) Sentaurus simulation showing the increased recombination at the trap states in the NDR regime for trap density of 10¹² cm⁻².

FIGS. 5a, 5b, 5c, 5d, 5e, 5f, 5g, 5h, and 5i. Oscillatory behavior of NDR device in conjunction with a FET based Hara active inductor. (a) Circuit diagram for oscillation measurements. (b) Experimentally measured V-t behavior for V_{applied}=0. (c) Fourier transform of the V-t curves of (b). (d) Frequency and amplitude of oscillation as a function of power density (e) Amplitude and (f) frequency of oscillation for different V_{applied} and power densities. (g)Frequency and amplitude of oscillation as obtained from the simulation, (h) colormap of amplitude and (i) frequency different V_{applied} and power densities as obtained from simulations.

FIGS. 6a, 6b, 6c, and 6d. Performance limits of the neuron and scaling opportunities. (a) Experimental scaling behavior of neurons showing the minimum optical power for spiking (b) Minimum optical intensity required for generating spike as a function dark current density showing the crossover between capacitance and dark current limited regimes (c) Different power components measured for a neuron of 0.25 cm² area showing the electrical power delivered by the DC voltage source (green) biasing the Hara inductor is not detectable within the measurement noise floor and electrical power generated by a neuron (red) from incident optical power (purple) is solely responsible for the oscillation. (d) Comparison of electrical power consumption of different artificial spiking neuron technologies. The external electrical power consumption for the neuron is theoretically zero while experimental measurement is limited by measurement noise floor.

FIGS. 7a, 7b, 7c, and 7d. Coupling between two oscillators. (a) Circuit diagram for coupling the oscillators. (b) Free running frequencies of the two oscillators as a function of V₁ and V₂ (c) Phase difference between the oscillators for different Z_{coupling} at V_{applied,1}=V_{applied,2}=0V. (d) Representative V-t curves showing the possibility of coupling even at larger Z_{coupling} values (larger R_{coupling} or smaller C_{coupling}, top two panels) when frequencies are matched.

FIGS. 8a, 8c, 8d, 8e, 8f, 8g, and 8h. Frequency multiplexed computation with ORN. (a) Circuit schematic for two coupled ORNs. (b) ORN voltage colormap showing nonlinear peak surfaces and their shift at different center frequencies for L_{c}=10 mH and BW=200 Hz. (c) ORN voltage colormap showing different peak surface shapes for different L_{c} values and their (d) analytical approximations. (e) Original image and the scatter plot showing all the (P₁,P₂) pairs for this image if it were input to a 1×2 convolutional kernel. (f-h) Image transformations when the two coupled ORNs (L_{c}=10 mH) receive the (P₁,P₂) pairs as inputs similar to a convolution operation and the corresponding scatter plots. The overlap between red and blue scatter plots show how different subsets of inputs are thresholded by the network at different center frequencies (BW=200 Hz).

FIGS. 9a, 9b, 9c, 9d, 9e, 9f, 9g, 9h, 9i, 9j, 9k, 9l, and 9m. Image processing with coupled ORN network. (a) Circuit schematic for the ORN kernel (b) I-V curves of all 9 SGM detectors in the network under same optical illumination. (c) Oscillation V-t and (d) FFT curves at the output node when all ORNs are under uniform illumination. (e) Frequency band filtered images showing edge detection, (f) intensity filtering, (g) image sharpening, (h) object segmentation. (i) Original color image and frequency domain images showing (j-m) image segmentation operation.

FIGS. 10a, 10b, 10c, and 10d: LSM implementation of ORN network for MNIST classification. (a) Image classification pipeline of the LSM structure showing an original input image, structure of the liquid layer, frequency sampled output images and further processing at the readout layer by hidden ReLU units. (b) Training and testing accuracy of the readout layer for training datasets corresponding to different frequency samples. (c) Classification accuracy of the handwritten digits as a function of number of frequency samples for 7×7 pixels/image and (d) for 21×21 pixels/sample.

### DETAILED DESCRIPTION

Reference will now be made in detail to presently preferred embodiments and methods of the present invention, which constitute the best modes of practicing the invention presently known to the inventors. The Figures are not necessarily to scale. However, it is to be understood that the disclosed embodiments are merely exemplary of the invention that may be embodied in various and alternative forms. Therefore, specific details disclosed herein are not to be interpreted as limiting, but merely as a representative basis for any aspect of the invention and/or as a representative basis for teaching one skilled in the art to variously employ the present invention.

It is also to be understood that this invention is not limited to the specific embodiments and methods described below, as specific components and/or conditions may, of course, vary. Furthermore, the terminology used herein is used only for the purpose of describing particular embodiments of the present invention and is not intended to be limiting in any way.

It must also be noted that, as used in the specification and the appended claims, the singular form “a,” “an,” and “the” comprise plural referents unless the context clearly indicates otherwise. For example, reference to a component in the singular is intended to comprise a plurality of components.

The term “comprising” is synonymous with “including,” “having,” “containing,” or “characterized by.” These terms are inclusive and open-ended and do not exclude additional, unrecited elements or method steps.

The phrase “consisting of” excludes any element, step, or ingredient not specified in the claim. When this phrase appears in a clause of the body of a claim, rather than immediately following the preamble, it limits only the element set forth in that clause; other elements are not excluded from the claim as a whole.

The phrase “consisting essentially of” limits the scope of a claim to the specified materials or steps, plus those that do not materially affect the basic and novel characteristic(s) of the claimed subject matter.

With respect to the terms “comprising,” “consisting of,” and “consisting essentially of,” where one of these three terms is used herein, the presently disclosed and claimed subject matter can include the use of either of the other two terms.

It should also be appreciated that integer ranges explicitly include all intervening integers. For example, the integer range 1-10 explicitly includes 1, 2, 3, 4, 5, 6, 7, 8, 9, and 10. Similarly, the range 1 to 100 includes 1, 2, 3, 4 . . . 97, 98, 99, 100. Similarly, when any range is called for, intervening numbers that are increments of the difference between the upper limit and the lower limit divided by 10 can be taken as alternative upper or lower limits. For example, if the range is 1.1. to 2.1 the following numbers 1.2, 1.3, 1.4, 1.5, 1.6, 1.7, 1.8, 1.9, and 2.0 can be selected as lower or upper limits.

When referring to a numerical quantity, in a refinement, the term “less than” includes a lower non-included limit that is 5 percent of the number indicated after “less than.” A lower non-included limit means that the numerical quantity being described is greater than the value indicated as a lower non-included limit. For example, “less than 20” includes a lower non-included limit of 1 in a refinement. Therefore, this refinement of “less than 20” includes a range between 1 and 20. In another refinement, the term “less than” includes a lower non-included limit that is, in increasing order of preference, 20 percent, 10 percent, 5 percent, 1 percent, or 0 percent of the number indicated after “less than.”

For any device described herein, linear dimensions and angles can be constructed with plus or minus 50 percent of the values indicated rounded to or truncated to two significant figures of the value provided in the examples. In a refinement, linear dimensions and angles can be constructed with plus or minus 30 percent of the values indicated rounded to or truncated to two significant figures of the value provided in the examples. In another refinement, linear dimensions and angles can be constructed with plus or minus 10 percent of the values indicated rounded to or truncated to two significant figures of the value provided in the examples.

With respect to electrical devices, the term “connected to” means that the electrical components referred to as connected to are in electrical communication. In a refinement, “connected to” means that the electrical components referred to as connected to are directly wired to each other. In another refinement, “connected to” means that the electrical components communicate wirelessly or by a combination of wired and wirelessly connected components. In another refinement, “connected to” means that one or more additional electrical components are interposed between the electrical components referred to as connected to with an electrical signal from an originating component being processed (e.g., filtered, amplified, modulated, rectified, attenuated, summed, subtracted, etc.) before being received to the component connected thereto.

The term “electrical communication” means that an electrical signal is either directly or indirectly sent from an originating electronic device to a receiving electrical device. Indirect electrical communication can involve the processing of the electrical signal, including but not limited to, filtering of the signal, amplification of the signal, the rectification of the signal, modulation of the signal, attenuation of the signal, adding of the signal with another signal, subtracting the signal from another signal, subtracting another signal from the signal, and the like. Electrical communication can be accomplished with wired components, wirelessly connected components, or a combination thereof.

The term “one or more” means “at least one” and the term “at least one” means “one or more.” The terms “one or more” and “at least one” include “plurality” as a subset.

The term “substantially,” “generally,” or “about” may be used herein to describe disclosed or claimed embodiments. The term “substantially” may modify a value or relative characteristic disclosed or claimed in the present disclosure. In such instances, “substantially” may signify that the value or relative characteristic it modifies is within ±0%, 0.1%, 0.5%, 1%, 2%, 3%, 4%, 5% or 10% of the value or relative characteristic.

The term “electrical signal” refers to the electrical output from an electronic device or the electrical input to an electronic device. The electrical signal is characterized by voltage and/or current. The electrical signal can be stationary with respect to time (e.g., a DC signal) or it can vary with respect to time.

The term “electronic component” refers is any physical entity in an electronic device or system used to affect electron states, electron flow, or the electric fields associated with the electrons. Examples of electronic components include, but are not limited to, capacitors, inductors, resistors, thyristors, diodes, transistors, etc. Electronic components can be passive or active.

The term “electronic device” or “system” refers to a physical entity formed from one or more electronic components to perform a predetermined function on an electrical signal.

The term “active inductor” refers to a circuit component that emulates the behavior of a traditional passive inductor but is implemented using active electronic components such as transistors or operational amplifiers. Typically, the impedance rises with frequency across some frequency range. The Hara active inductor is a simple active inductor using a common-source cascade FET with a resistive feedback. (see for example, S. Hara, T. Tokuitsu, T. Tanaka and M. Aikawa, “Broad-Band Monolithic Microwave Active Inductor and Its Application to Miniatrized Wide-Band Amplifiers”, IEEE Trans. Microwave Theory Tech., vol. 36, pp. 1920-1924, December 1988 and S. Hara, T. Tokuitsu and M. Aikawa, “Lossless Broad-Band Monolithic Microwave Active Inductors”, IEEE Trans. Microwave Theory Tech., vol. 37, pp. 1979-1984, December 1989; the entire disclosures of which are hereby incorporated by reference.)

It should be appreciated that in any figures for electronic devices, a series of electronic components connected by lines (e.g., wires) indicates that such electronic components are in electrical communication with each other. Moreover, when lines directed connect one electronic component to another, these electronic components can be connected to each other as defined above.

Throughout this application, where publications are referenced, the disclosures of these publications in their entireties are hereby incorporated by reference into this application to more fully describe the state of the art to which this invention pertains.

### Abbreviations:

“BW” means bandwidth.
“LSM” means liquid state machine.
“NDR” means negative differential resistance.
“ORN” means oscillatory retinal neuron.
“SMG” means semiconductor-graphene-metal.
“TCAD” means Technology Computer-Aided Design.

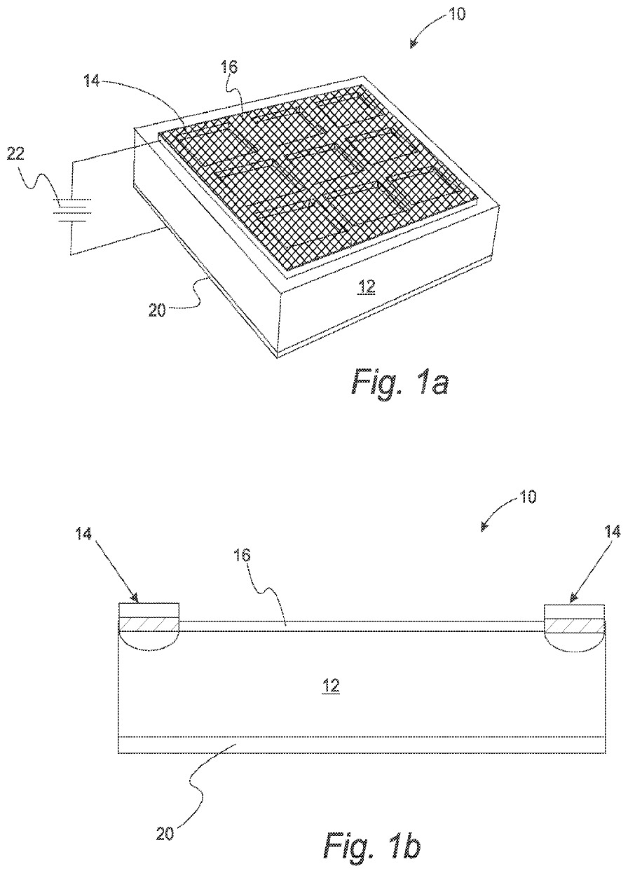

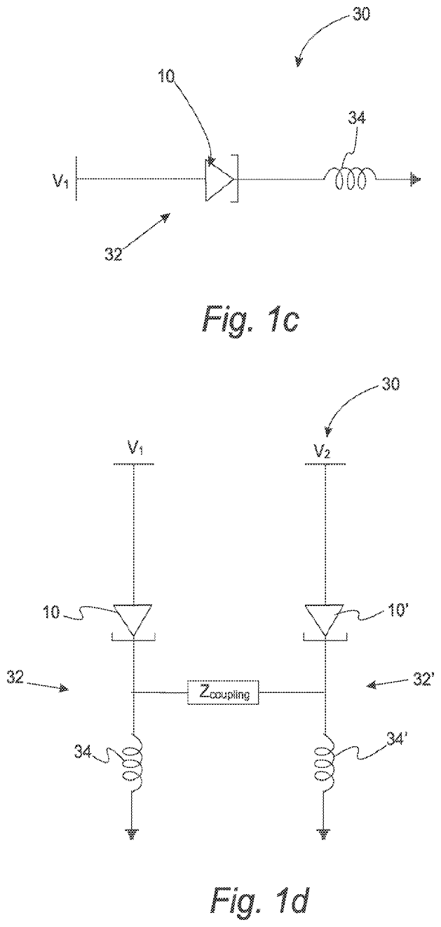

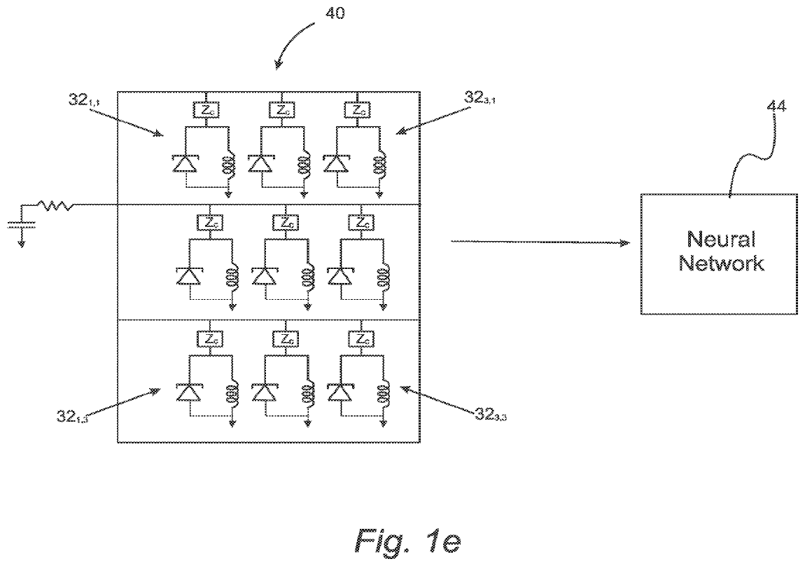

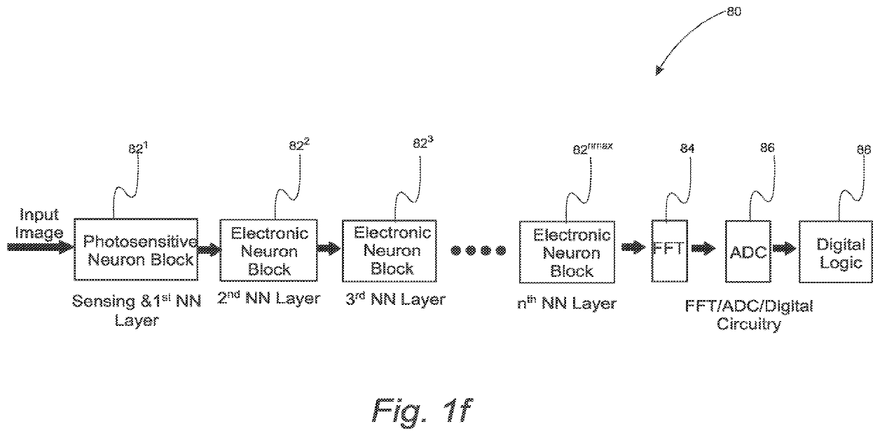

With reference to FIGS. 1a and 1b, schematics of a silicon-graphene-metal photodetector that exhibits NDR are provided. Silicon-graphene-metal photodetector 10 includes silicon substrate 12 which has a first face and a second face. Typically, wherein the silicon substrate is composed of p-doped silicon. Metal contact, and in particular, a patterned metal contact 14 disposed over the first face of the silicon substrate 12 to form a metal-semiconductor contact. In a refinement, the patterned metal contact is patterned as a rectangular grid. However, it should be appreciated that a grid of arbitrary two-dimensional shapes can be used. Graphene sheet 16 contacts both the silicon substrate 12 and the patterned metal contact 14 such that to form a graphene-semiconductor contact. In another refinement, the bottom metallic contact layer 20 is disposed over the second face NDR can occur during positive power generation.

Silicon-graphene-metal photodetector 10 can be operated with or without exposure to light. In a refinement, a bias voltage from voltage source 22 is applied across the patterned metal contact and the bottom metallic contact layer is biased at a sufficient voltage for inducing oscillations when exposed to light. In a further refinement, the bias voltage is from −0.5 and +0.5 volts. In a further refinement, the bias voltage is from −0.2 to 0.2 volts. In another variation, a bias voltage is not applied across the patterned metal contact and the bottom metallic contact layer. The variations described herein are not particularly limited by the frequency of the oscillations. In a refinement, the frequency of the oscillations is from 10 Hz to 1 MHz. In a further refinement, the frequency of the oscillations can be from 50 Hz to 10 kHz.

With references to FIGS. 1c and 1d, schematic illustrations of a sensing device are provided. Sensing device 30 includes a first retinal circuit 32. First retinal circuit 32 includes a first silicon-graphene-metal photodetector 10 which includes a silicon substrate having a first face and a second face; a patterned metal contact disposed over the first face of the silicon substrate to form a metal-semiconductor contact; a graphene sheet contacting both the silicon substrate and the patterned metal contact such that to form a graphene-semiconductor contact; and a bottom metallic contact layer disposed over the second face of the silicon substrate as set forth above. Sensing device 30 also includes a first inductive component 32 in electrical communication with the first silicon-graphene-metal photodetector 10 as described for FIGS. 1a and 1b. As set forth above, the first silicon-graphene-metal photodetector 10 can be operated with exposure to light. Finally, first retinal circuit 32 is biased with voltage V₁. The bias voltage is applied across the patterned metal contact and the bottom metallic contact layer is biased at a sufficient voltage for inducing oscillations. In a refinement, the bias voltage is from −0.5 and +0.5 volts. In a further refinement, the bias voltage is from −0.2 to 0.2 volts. In another variation, a bias voltage is not applied across the patterned metal contact and the bottom metallic contact layer is biased. Advantageously, the first retinal circuit can be operated as an oscillator (e.g., a relaxation oscillator).

FIG. 1d depicts a variation in which sensing device 30 includes a second retinal circuit 32′ electrically coupled to the first retinal circuit 32 with an impedance component. The second retinal circuit 32′ includes a first silicon-graphene-metal photodetector 10′ of the design set forth above and a second inductive component 34′. In a refinement, a second retinal circuit electrically coupled to the first retinal circuit with an impedance component z_{coupling}. The impedance component can be a capacitor, resistor, or MOSFET. Advantageously, the second retinal circuit can be operated as an oscillator (e.g., a relaxation oscillator).

With reference to FIG. 1e, a schematic illustration of a sensing array. Sensing array 40 includes a plurality of retinal circuits 32ᵢⱼ where i and j are integer labels for each dimension of the array. Each retinal circuit includes silicon-graphene-metal photodetector as described above and an inductive component. Retinal circuits 32ᵢⱼ are coupled by impedance component Zc as set forth above. In a variation, a bias voltage is applied across the patterned metal contact and the bottom metallic contact layer of each retinal voltage at a sufficient voltage for inducing oscillations as set forth above. Advantageously, each retinal circuit can be operated as an oscillator (e.g., a relaxation oscillator).

Still referring to FIG. 1e, retinal circuits are interconnected with reconfigurable connections between oscillators (i.e., retinal circuits). In a refinement, the retinal circuits are interconnected with transistors. In a variation, the reconfigurable connections are configured to perform insensor computing at low power. For example, the reconfigurable connections are configured to perform image processing functions. In this regard, the retinal circuits can be connected with various connection schemes to perform such operations (e.g., nearest neighbor connections, connections with more distant retinal circuits, and combinations thereof.) In another variation, Sensing array 40 is configured to provide input to a neural network 44.

Figure if provides a schematic of a hardware implementation of a sensor system that can be applied to the sensing devices of FIGS. 1c and 1d or the sensor array as of FIG. 1e. Sensor system 80 includes a photosensitive neural block 82¹ which includes the sensing device and a first neural network layer. The first neural network is in electrical communication with and receives input from the sensing device. As set forth above, the sensing device can include a retinal circuit having a silicon-graphene-metal photodetector that includes a silicon substrate having a first face and a second face; a patterned metal contact disposed over the first face of the silicon substrate to form a metal-semiconductor contact; and a graphene sheet contacting both the silicon substrate and the patterned metal contact such that to form a graphene-semiconductor contact. Characteristically, NDR occurs during positive power generation. The silicon-graphene-metal photodetector that also includes a bottom metallic contact layer disposed over the second face of the silicon substrate. The sensing device also includes an inductive component in electrical communication with the first silicon-graphene-metal photodetector. Advantageously, the first retinal circuit is operatable as an oscillator. Sensor system 80 includes one or more additional neural network layers 82ⁿ where n is an integer labeling the neural network layers running from 2 to nmax which is the total number of neural network layers. Fast Fourier transform circuit 84 is in electrical communication with and receives input from the one or more additional neural network layers 82ⁿ (a last neural network 82^{nmax} and receives the output therefrom as input. In a refinement, an analog-to-digital converter 86 in in electrical communication with Fast Fourier transform circuit and is configured to digitize the output from Fast Fourier transform circuit 84. In a further refinement, digital logic circuitry 88 is in electrical communication with digital converter 86. The output from analog to digital converter 86 is provided to for processing. Sensor system 80 can be realized in hardware by any number of methods known to those skilled in the art. The sensing device is inherently only realized in hardware. The neural network layers can be implemented in hardware via application-specific integrated circuits, field-programmable gate arrays, neuromorphic chips, and the like. Similarly, fast Fourier transform circuit 84 can also be implemented by application-specific integrated circuits. Finally, analog-to-digital converter 86 and digital logic 88 are inherently implemented in hardware.

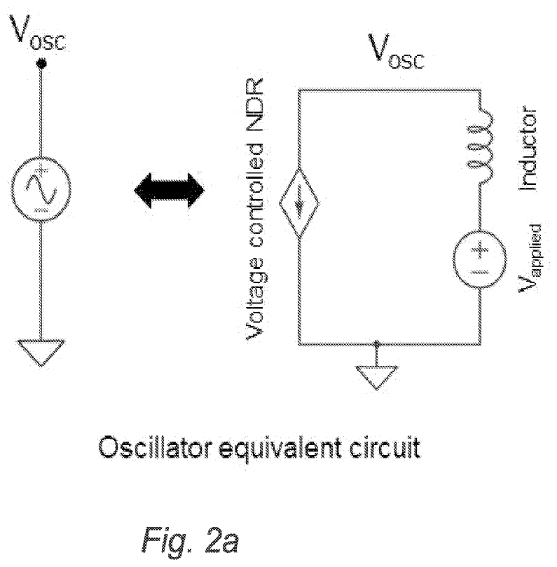

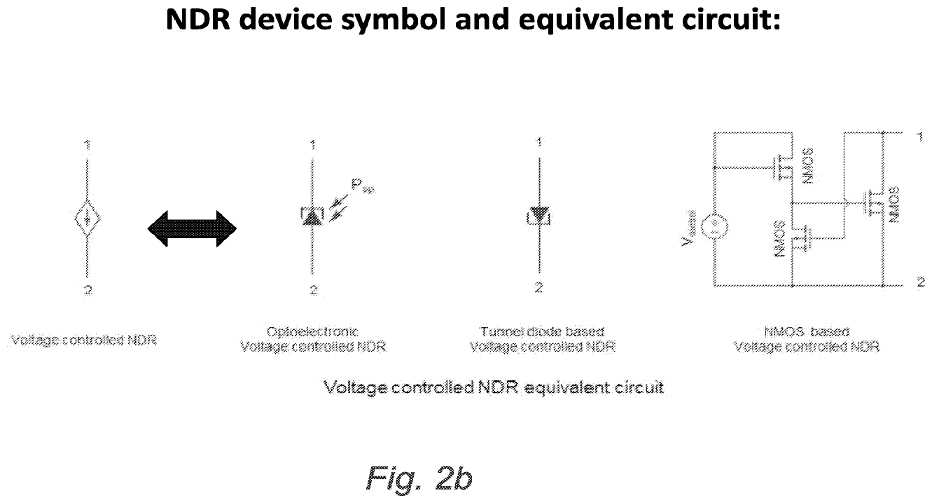

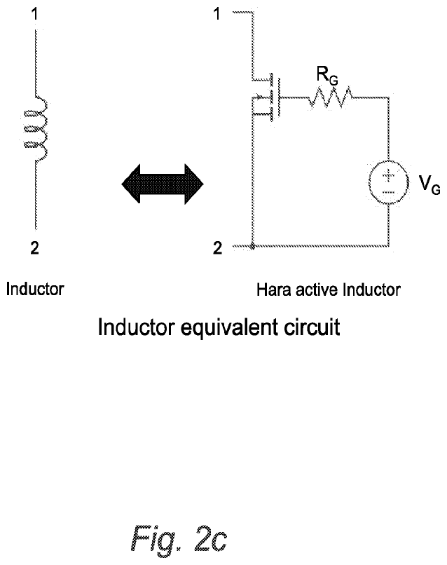

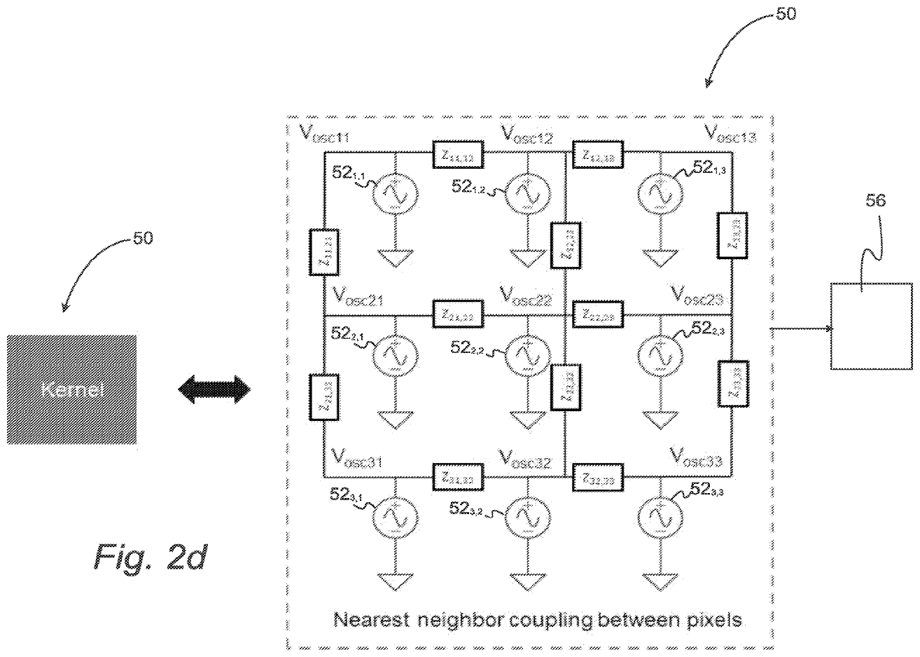

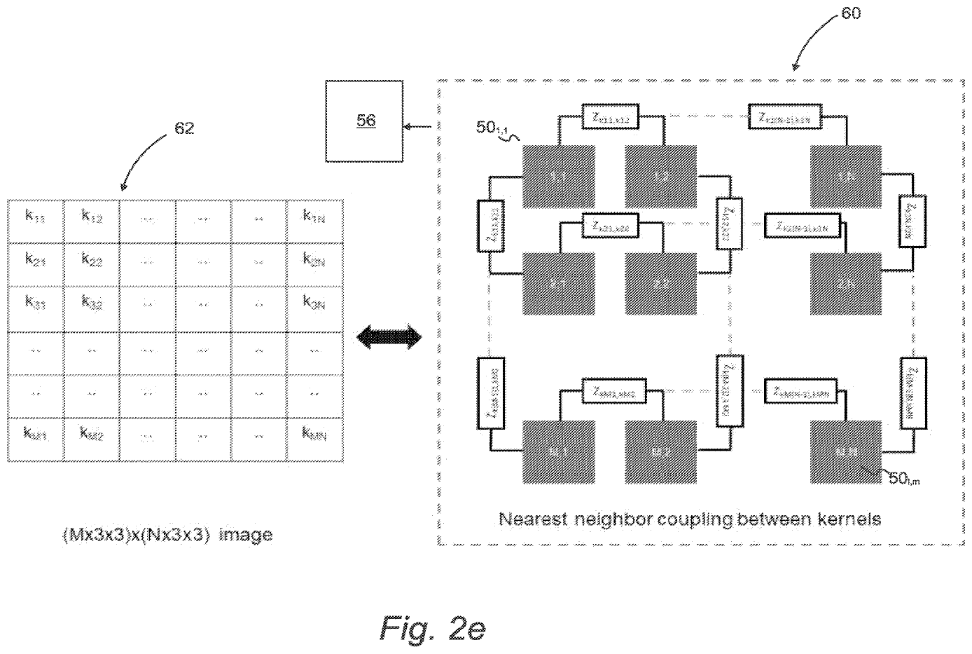

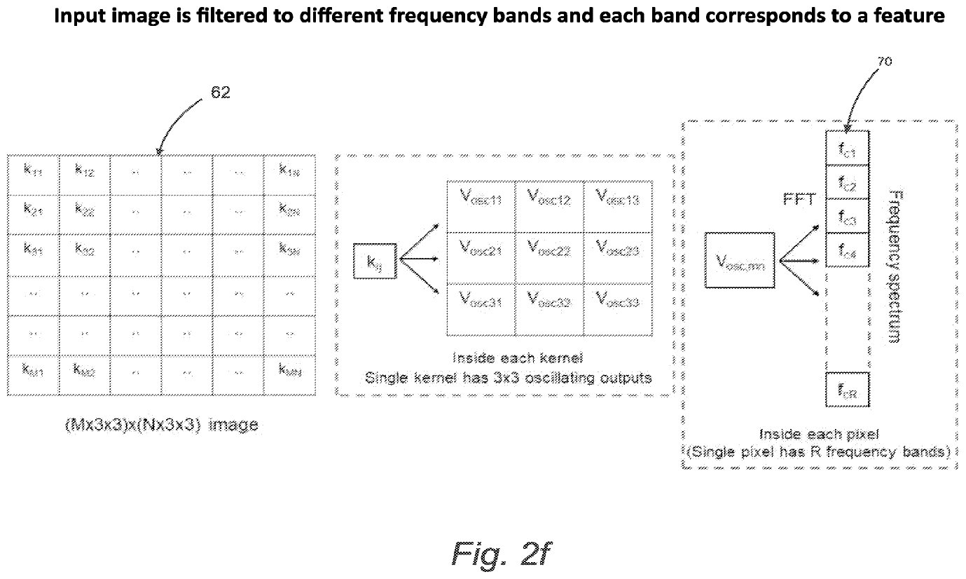

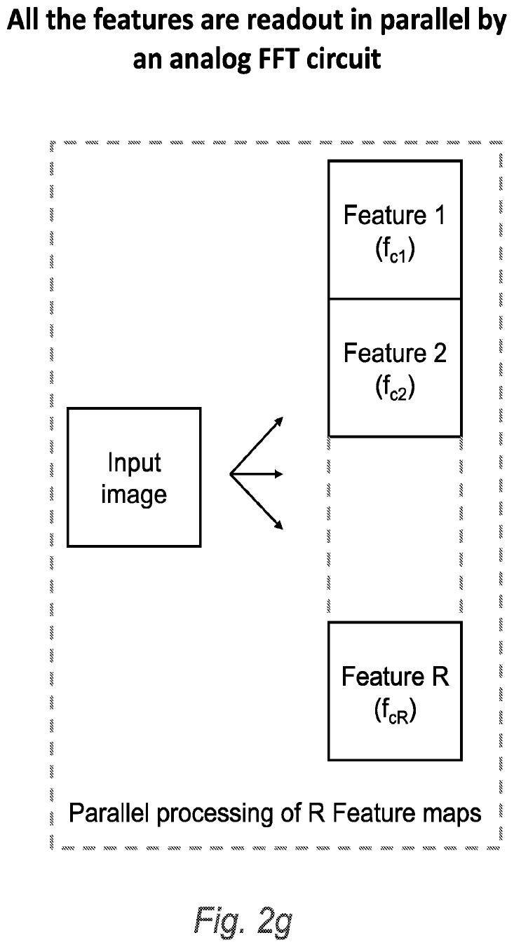

With reference to FIGS. 2a, 2b, 2c, 2d, 2e, 2f, and 2g, schematics depicting a computing device that can incorporate the retinal circuits described above are provided. FIG. 2a provides a schematic of an oscillator equivalent circuit. The left side gives the symbol of the oscillator that will be used in the schematics for the computing devices. FIG. 2b provides symbols of voltage control NDR that can be used in the oscillator of FIG. 2a. The optoelectronic voltage-controlled NDR results in the oscillator being the retinal circuits described herein. FIG. 2c provides symbols of inductor-equivalent circuits that can be used in the oscillator of FIG. 2a. The left side gives the symbol of the symbol that will be used in the schematics for the computing devices, but it is understood that it is the Hara active inductor on the right. FIG. 2d provides a schematic of a kernel that can be used in the computing device. Kernel 50 includes a plurality of oscillators 52ij where i and j are integer labels for the oscillators. In a refinement, the oscillator include an optoelectrical voltage-controlled component such as the silicon-graphene-metal photodetector 10 of FIG. 1. Therefore, the oscillators can be the retinal circuits described above. It should be appreciated that any voltage controlled NDR component can be used such as the examples in FIG. 2b. Typically, the plurality of oscillators is arranged as a 2-dimensional array. In a refinement, the oscillators are coupled by the impedance components with nearest neighbor coupling. The coupling scheme with nearest neighbor coupling between pixels in a kernel is depicted in FIG. 2d. In a refinement, each oscillator is a retinal circuit that includes silicon-graphene-metal photodetector as described above and an inductive component. Retinal circuits 52ᵢⱼ are coupled by impedance component Z_{ij,i′j′} where i, j, i′, j′ are integer labels for the impedance having values to indicate the oscillators being coupled with the impedance. The ′ indicated the label for a nearest neighbor retinal circuit. In a variation, a bias voltage is applied as indicated in FIG. 2a. Advantageously, each oscillator is configured to receive input from a portion of an input data set (pixels or portions of an image). A readout device 56 is in electrical communication with the kernel 50 to read an output voltage (Vosc) versus time from each oscillator (e.g., retinal circuits 52ij) and perform bandpass filtering operations as described below.

With reference to FIG. 2e, a schematic of a computing device is provided. Computing device 60 operates on image 62 which is divided into a plurality of regions that can correspond to pixels. Computing device 60 includes a plurality of kernels 50₁ₘ where l,m are integer labels for the kernels as provided by FIG. 2d. As set forth above, each kernels 50ₗₘ includes a plurality of oscillators. Each oscillator includes a negative differential resistance component as described above. a plurality of impedance components that couple the oscillators together, Advantageously, each oscillator is configured to receive input from and therefore associated with a portion of an input data set. In a refinement, the input data set is an image, and each portion of the input data set corresponds to a pixel. Referring to FIG. 2e, image 62 is projected onto the kernel such that each oscillator received input from a pixel k_{MN} in the image. In a refinement, each oscillator corresponds to a pixel in an input image. In the example depicted in FIG. 2d, the oscillators in the kernels are arranged as 3×3 arrays. Therefore, each kernel receives input from 9 pixels. The plurality of kernels in computing device 60 are coupled together by impedance component Z_{kM(-1),kMN} where k, M, and N are integer labels. In a refinement, the plurality of kernels 50ₗₘ are coupled by the impedance components with nearest neighbor coupling. Computing device 60 also includes a readout system 56 to read an output voltage versus time from each oscillator and perform bandpass filtering operations. Characteristically, the readout system is configured to simultaneously provide a plurality of measurable features for each portion of an input data set that was inputted. When the spatial configuration of the pixels is considered, a feature map can be constructed with the feature value being given at the location of each pixel. Advantageously, computing device 60 can be configured to compute image edges, to compute image intensity zone, to sharpen images, and/or to perform image segmentation. Moreover, computing device 60 can be configured to perform computations in parallel as each band is associated with a computation.

As set forth above, each oscillator in kernels 50_{l,m} can be a retinal circuit that includes a first silicon-graphene-metal photodetector including a silicon substrate having a first face and a second face and a patterned metal contact disposed over the first face of the silicon substrate to form a metal-semiconductor contact. The first silicon-graphene-metal photodetector also includes a graphene sheet contacting both the silicon substrate and the patterned metal contact such that to form a graphene-semiconductor contact where NDR occurs during positive power generation, and a bottom metallic contact layer disposed over the second face of the silicon substrate. Each oscillator also includes a first inductive component in electrical communication with the first silicon-graphene-metal photodetector, wherein the first retinal circuit is operatable as an oscillator. In a refinement, the first inductive component is an active inductor (e.g., Hara active inductor).

In a variation, the readout circuit 56 includes a Fourier transform circuit, and in particular, a fast Fourier transform circuit, that outputs a frequency spectrum for each oscillator. An example of a particularly useful low-power FFT circuit is provided by B. Sadhu, M. Sturm, B. M. Sadler and R. Harjani, “Analysis and Design of a 5 GS/s Analog Charge-Domain FFT for an SDR Front-End in 65 nm CMOS,” in IEEE Journal of Solid-State Circuits, vol. 48, no. 5, pp. 1199-1211, May 2013, doi: 10.1109/JSSC.2013.2250457; the entire disclosure of which is hereby incorporated by reference in its entirety. As depicted in FIG. 2f, the frequency spectrum for each oscillator is divided into a plurality of frequency bands 70. As depicted in FIG. 2g, each frequency band can provide a measurable feature. When the measurable feature for each band is plot with the spatial distribution of the pixels, a feature map or image map is created.

The following examples illustrate the various embodiments of the present invention. Those skilled in the art will recognize many variations that are within the spirit of the present invention and scope of the claims.

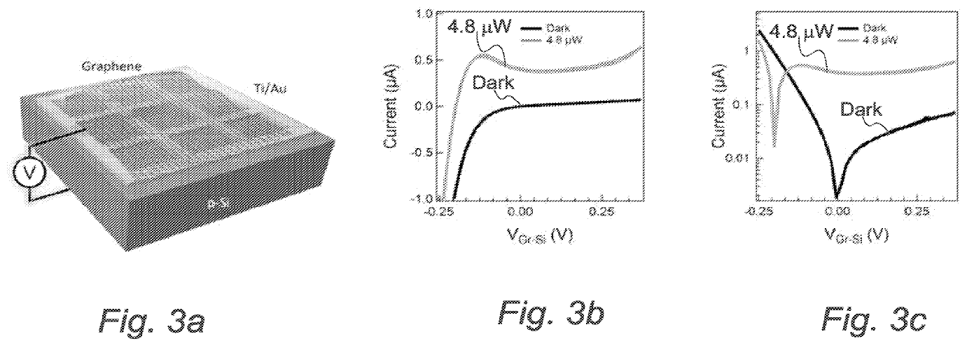

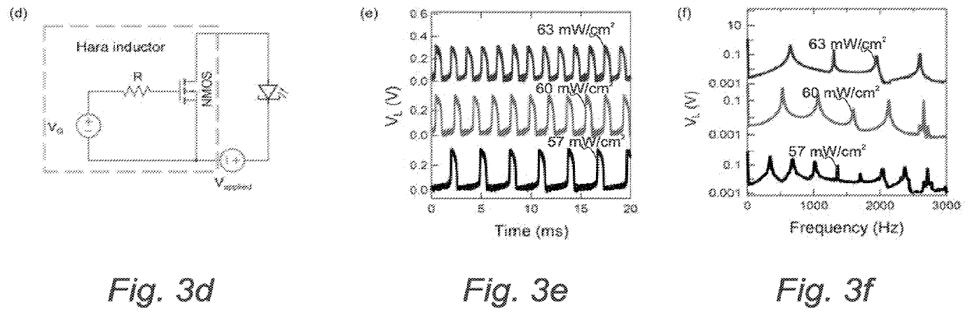

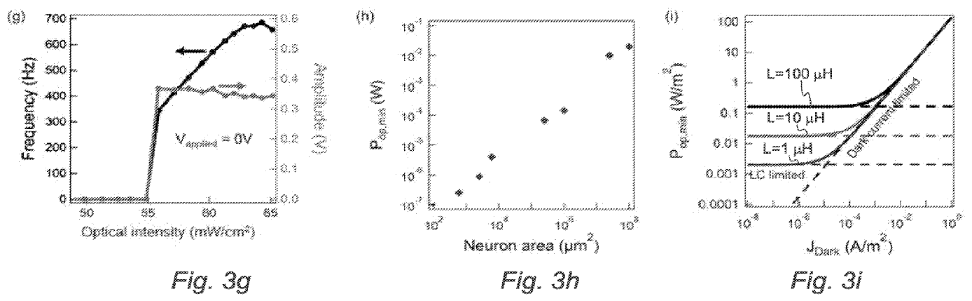

With refinement to FIG. 3, the ORNs disclosed herein are composed of two elements, (i) a photodetector that exhibits voltage-controlled negative differential resistance (NDR) under illumination and (ii) an inductive element that can drive an electrical oscillation by taking advantage of the instability of the NDR behavior. A semiconductor-graphene-metal (SGM) photodetector, schematically shown in FIG. 3a, exhibits NDR in the detector's power generation regime. The device comprises a p-type silicon substrate, a Ti/Au (5 nm/100 nm) metal grid, and a graphene layer. Linear scale I-V measurements of a 1 mm×1 mm device under dark and uniform optical illumination are shown in FIG. 3b. In the dark, the device exhibits Schottky-diode behavior, while exhibiting NDR under illumination. FIG. 3c shows the log-scale I-V curves, highlighting that the NDR is only observed under illumination. Connecting this device with an inductive element under appropriate bias conditions generates optical intensity dependent oscillations, as shown schematically in FIG. 3d. An active inductive element, the Hara inductor, comprising a single MOSFET and a resistor, enables the scalability of the ORN. The observed oscillations are analogous to classical Van der Pol oscillators and the Fitzhugh-Nagumo model of neurons.

To explore the scaling behavior of ORNs, photodetectors with areas between 600 μm² and 1 cm² have been fabricated and evaluated. The minimum optical power required for oscillation without external electrical power scales linearly with the device area, as shown in FIG. 3h. Two parameters limit the oscillation dynamics of ORNs, the dark current and the capacitance. First, the dark current does not exhibit NDR and adds with the light current. Second, the photon flux should generate sufficient light current so that the valley of the NDR is greater than the dark current. There must also be sufficient photocurrent to charge and discharge the capacitance at timescales of the oscillation frequency. The addition of external power can mitigate this limitation. For a moderately doped p-Si substrate, the depletion capacitance at the graphene-silicon junction is ˜0.1 fF/μm². FIG. 3i shows the minimum optical intensity for oscillation assuming a device capacitance of 0.1 fF/μm² as a function of device dark current density. A crossover between two different regimes is observed: (1) inductance-capacitance (LC) limited regime at smaller dark currents and (2) dark current limited regime at larger dark currents. For the photodetectors, the Schottky nature of the junction results in a larger dark current, limiting the threshold optical intensity to ˜400 W/m². At smaller dark current densities, it is possible to decrease this threshold to below 2 mW/m².

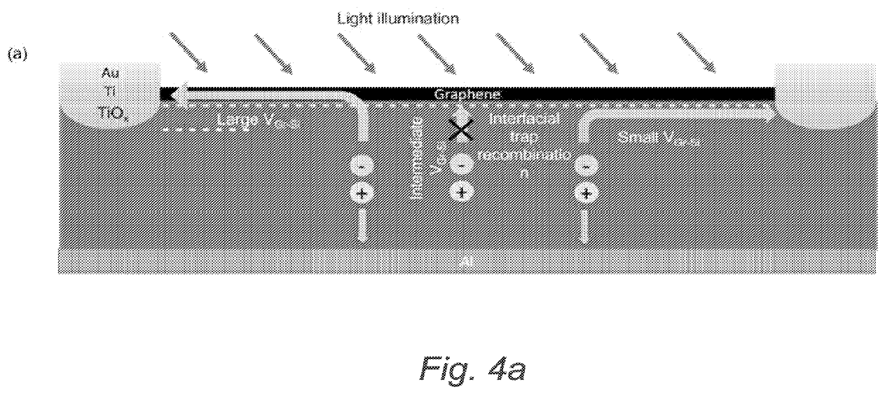

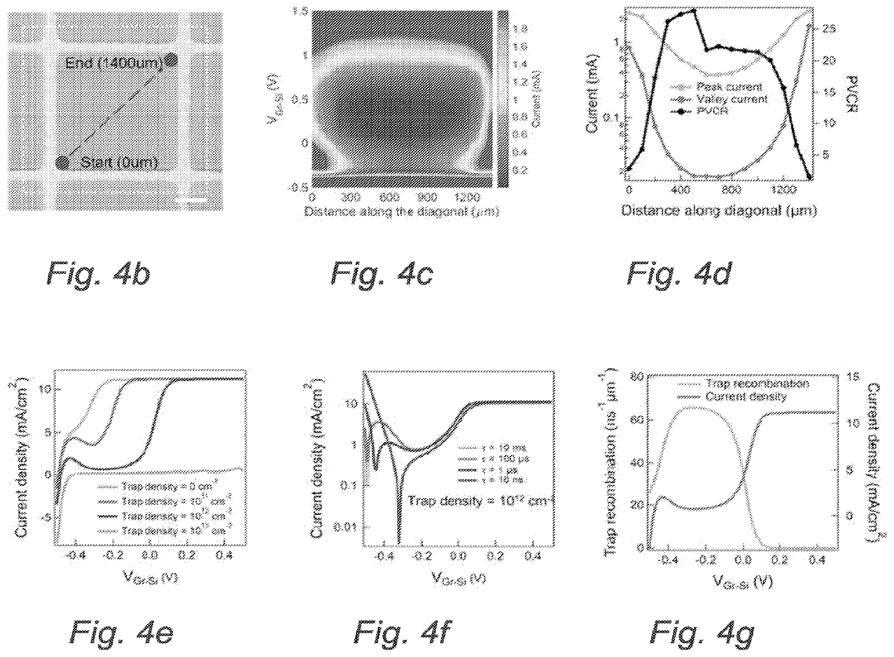

FIG. 4a shows a schematic of a model for the observed NDR behavior in the device of FIG. 3a. The photogenerated electrons can be collected by two possible channels: (1) lateral diffusion in the plane of the silicon surface to reach the Ti/Au contact or (2) collection into graphene through the thin native oxide barrier. These two collection channels compete with recombination processes at the Si/graphene interface and bulk. At smaller voltages, the native oxide barrier is opaque, and the majority of electrons are collected at the Ti/Au contact region. When the voltage is increased, the barrier between the graphene and native oxide barrier becomes less opaque and causes electrons to flow toward the silicon/native oxide interface. However, the surface Fermi level will also move, modifying the density of unoccupied interface defect states, which modifies the interfacial recombination rates. As the voltage is increased further, the native oxide barrier now becomes even more transparent, and the defect states are now occupied so that the electrons can tunnel into graphene without going through recombination (photoconductive regime).

To verify the proposed mechanism, a position-dependent I-V measurement on the device using a focused laser beam of 532 nm wavelength with a spot size of ˜100 μm² and power of 12.6 mW was performed. The beam through the diagonal of a single mesh was scanned as shown in FIG. 4b. A change in I-V characteristics as a function of the distance between the beam and the metal grid is observed. Due to the square geometry of the mesh, the distance from the contacts is maximum when the beam is at the midpoint of the diagonal. FIG. 4c shows a color map of the device's current magnitude as the voltage and the distance along the mesh diagonal are swept. For VGr-Si<1 V, the current varies with distance along the diagonal. FIG. 4d shows a line plot of the peak, valley, and peak-to-valley current ratio (PVCR) as a function of the distance along the mesh diagonal. The peak PVCR occurs when light is incident in the middle of the diagonal driven by the large relative change in valley current. The temperature-dependent I-V shows that the NDR behavior does not have a significant dependence on temperature, consistent with the proposed model. The C-V characteristics of the device under different illumination conditions and small-signal frequencies have been measured. C-V curves for the device measured at a small signal frequency of 1 kHz under uniform optical illumination with varied power densities at 445 nm wavelength were obtained. The dark C-V curve shows an initial increase in capacitance due to the formation of a depletion region and then a decrease in the capacitance as the width of the depletion region increases with increasing reverse bias voltage. The C-V behavior under illumination shows a larger initial capacitance followed by a sharper decrease in capacitance for lower voltages. The larger capacitance under illumination can be attributed to the increase in charge in the depletion region due to photogenerated carriers while the sharp decrease can be attributed to the presence of a recombination process that annihilates these photogenerated carriers. When the voltage is increased further, another slow increase is observed followed by a slow decrease in capacitance, unlike the dark measurements. When these C-V measurements are compared with the higher frequency C-V measurements, the second increase in the capacitance is observed to disappear at the higher frequencies. This frequency-dependent behavior supports the hypothesis that charges responsible for the second increase in capacitance are due to slow charge trapping centers in the device. Advantageously, these experimental results agree with the mechanism proposed in FIG. 4a.

To further validate the mechanism, TCAD Sentaurus simulations of the device were performed⁶². FIG. 4e shows the simulated J-V curves of the device under the illumination of 65 mW/cm² light of 445 nm wavelength for different electron trap densities in the native oxide. As the trap density is increased, it can be observed that the emergence of NDR behavior which again vanishes when the trap density becomes too large. FIG. 4g shows the effect of bulk electron lifetime in silicon on the NDR behavior for a trap density of 10¹² cm⁻². When the lifetime is short (10 ns), the bulk recombination dominates over the interfacial recombination, and therefore no NDR is observed. However, NDR is observed when carriers have a long lifetime (>100 μs) in the bulk and interfacial recombination becomes more prominent. FIG. 4h shows the recombination rate at the electron trap states for a trap density of 10¹² cm⁻² as well as the J-V curve. An increase in recombination rate at the trap states when the NDR regime starts is observed followed by a subsequent decrease in recombination rate as NDR regime ends and the current starts to increase. While the experimental results show that the charge trapping states at the silicon/oxide interface are responsible for the NDR behavior, the TCAD simulations help to quantitatively verify the validity of the proposed mechanism.

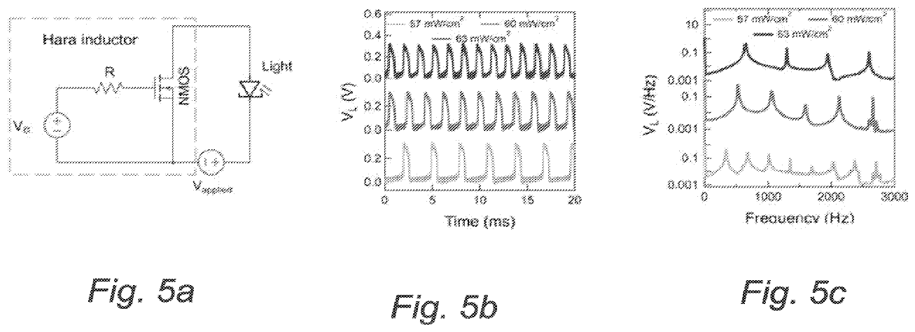

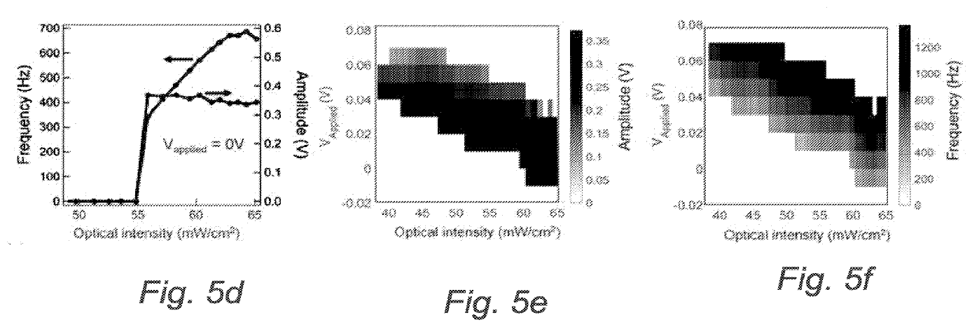

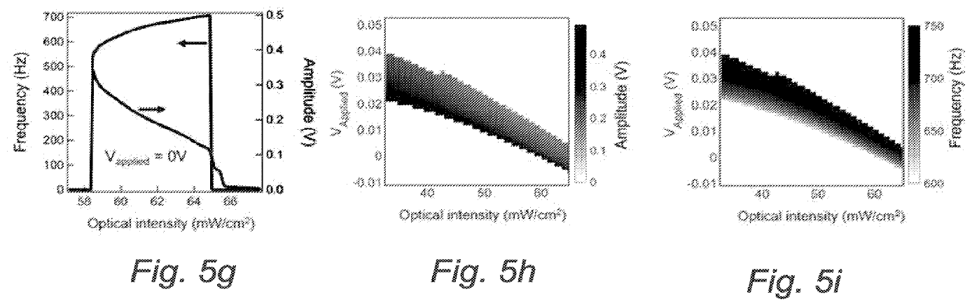

After elucidation of the NDR mechanism, the oscillation behavior of these devices was explored when connected to an inductive element. FIG. 5 shows the relaxation oscillation behavior of the device when connected in series to a Hara inductor. FIG. 5a shows the circuit configuration for the oscillation measurements. The V-t curves measured at different optical power densities (445 nm wavelength) for V_{applied}=0V are shown in FIG. 5b and their corresponding fast Fourier transform (FFT) curves are shown in FIG. 5c. The V-t and FFT curves show that increasing the optical power causes an increase in the fundamental frequency of oscillation while the amplitude of oscillation remains somewhat constant as summarized in FIG. 5d. FIG. 5e-f show the colormap of the oscillation amplitude and frequency as a function of optical power density and applied voltage. To confirm these results, additional measurements were performed with inductors and op-amp based gyrators, showing that both approaches also generate relaxation oscillations. Advantageously, Hara active inductor consists of just one FET and a resistor, which allows scalability of this element, unlike coil-based inductive elements.

FIG. 5g shows the simulated frequency and amplitude behavior of the oscillator as a function of optical power density shows good quantitative agreement between the simulated and experimental data as shown in FIG. 5d. Then the oscillations were simulated for different V_{applied} and optical power densities and generated colormaps for the oscillation amplitude (FIG. 5h) and frequency (FIG. 5i). These colormaps can accurately reproduce the trends observed in experiments as shown in FIG. 5h-i. To conduct these circuit simulations, a numerical model of the neuron was built using experimental I-V and C-V data. By accurately reproducing the trend and numerical behavior of the device vs Vapplied and optical power density, these simulations can be used to accurately estimate the behavior of the oscillator. These models also show good quantitative agreement for inductor-based neurons.

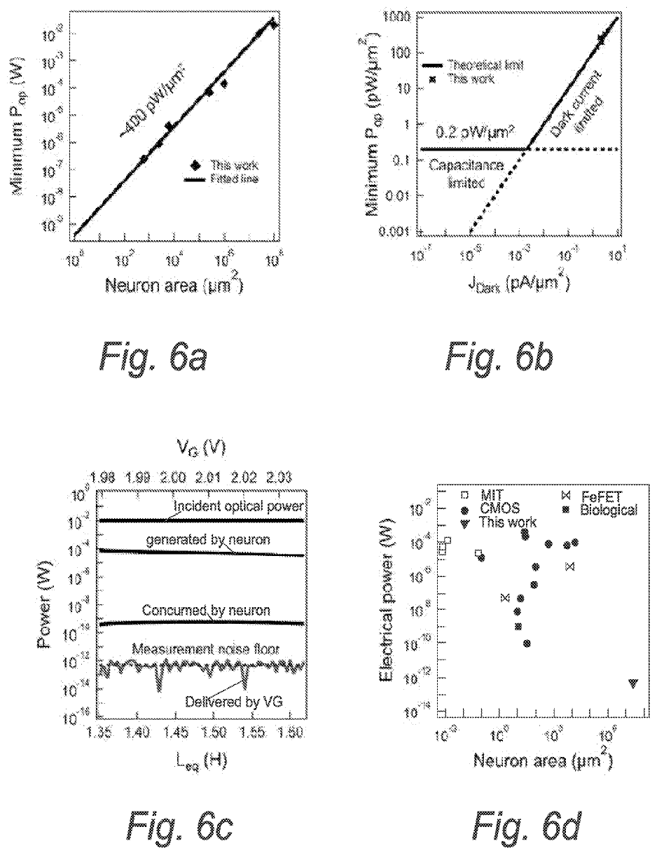

Optical neurons with areas between 600 m² and 1 cm² (covering ˜6 orders of magnitude for device area) were fabricated and the oscillation properties measured. FIG. 6a shows the minimum optical power for spiking as a function of neuron area. As shown by the fitted line across the squares, the minimum optical power for spiking scales linearly with area. These devices require a minimum optical intensity of ˜400 pW/μm² to generate spiking oscillations. Using both the device and circuit models developed, the performance limits of the neuron can be theoretically predicted. There are two main factors that prevent oscillations at lower optical powers: (1) the dark current of the device and (2) the capacitance of the device. The diode current, iD and the graphene current, iGr directly contribute to the dark current of the device and limit the current (iNDR) delivered by the device suppressing NDR behavior. The practical minimum the dark current can be achieved if the dark current could be limited to the reverse saturation current of a pn junction diode for a given doping (5×10¹⁵ cm⁻³) which is ˜10⁻⁷ pA/μm² (˜1 pA/μm² for the device, ˜10⁻⁶ pA/μm² for commercial silicon photodiodes). The current, iNDR delivered by the device at a voltage v_{d} is then distributed into three different branches: (1) the device capacitance (Cd), (2) the gate capacitance (Cgs) and its series resistance I, and (3) the inductive branch with a series resistance of 1/gm and inductance of L=RCgs/gm. The relative values of Cd, Cgs, R and gm decide the fraction of iNDR going into each branch. The minimum capacitance of the device (Cd) for 5×10¹⁵ cm⁻³ doping level is ˜0.1 fF/μm² (˜10 fF/μm² for the device). The power generated by the device, therefore, needs to compensate for all the resistive losses in the circuit as well as meet the current demands of each branch to start and sustain oscillation.

A numerical simulation to find the practical performance limits of the neuron was performed. A hypothetical SGM device of 1 μm² area was considered that assumed a minimum capacitance of ˜0.1 fF, and run simulations by connecting it with a Hara inductor for different optical powers. For the Hara inductor, it was also assumed an NMOS in the 45 nm process, 2.3 nm gate oxide, WFET/LFET=10, gm=10 nS and a Cox=0.1 fF. Significantly, the required optical power for oscillation decreases and so does the oscillation frequency. Since biological neurons typically show an oscillation frequency ˜100 Hz, the minimum operating power Pₒₚ required for 100 Hz oscillations was identified to be ˜0.2 pW which is 5000× smaller than the solar AM1.5 irradiation on a 1 μm² area. It was further explored how the device capacitance and dark current limit the performance of the neuron. Moreover, the minimum optical intensity required to generate spiking oscillation increases almost linearly with the increase in device capacitance. FIG. 6b shows the minimum optical intensity for spiking for a device capacitance of 0.1 fF/μm² as a function of dark current density of the device. A crossover between two different regimes can be seen: (1) capacitance limited regime at smaller dark currents and (2) dark current limited regime at larger dark currents. When the current is very small, the device capacitance cannot be charged and discharged fast enough, thereby preventing the oscillations below a threshold current and consequently a threshold optical intensity. On the other hand, when the dark current is large, NDR behavior is only observed at larger optical intensities, hence giving rise to this crossover between two different regimes.

There are two different sources of power in this neuron: (1) optical power that is converted into electrical power by the SGM device and (2) electrical power supplied by the DC voltage source V_{G}. Electrical power delivered by VG can be calculated from

$${P}_{e l e c} = \frac{1}{T} {\int }_{0}^{T} {V}_{G} {i}_{g} dt = \frac{1}{T} {\int }_{0}^{T} {V}_{G} [ {i}_{g , dc} + {\sum }_{n = 1}^{∞} {a}_{n} sin ( n ω t ) ] dt = \frac{1}{T} {\int }_{0}^{T} {V}_{G} {i}_{g , dc} dt .$$

Since i_{g} is also the current through the gate capacitor (Cgs), there is no DC component to this current (i_{g,dc}=0), and P_{elec}=0. Therefore, there is no external electrical power required at all to drive these oscillations if the electrical power generated by the SGM device is enough to compensate for all the losses in the system. FIG. 6c shows the different power components in a neuron with 0.25 cm² active area as VG and L_{eq} are varied. For this neuron, a commercial 2N7000 MOSFET was used where C_{gs}=400 pF with a series resistance, R=20 MΩ. When increasing VG for the MOSFET in saturation, gm decreases, and therefore series resistance 1/gm and equivalent inductance L_{eq} increases. Oscillations were observed between VG=1.97V and VG=2.04 V for an incident optical power of 10 mW (an optical intensity of 400 pW/μm²). The maximum power conversion efficiency of the SGM device is ˜1% of this optical power. For VG<1.97V, gm is too large, and the electrical power dissipated at gm exceeds the maximum power deliverable by the device and for VG>2.04 V, gm is too small so that the negative resistance of the SGM device is compensated by series resistance 1/gm and oscillations cannot be observed anymore. The average power burned in R due to continuous charging and discharging of Cgs is ˜1 nW which is ˜5 orders of magnitude smaller than the generated electrical power. The transconductance of MOSFET burns almost 100% of the power generated by the SGM device. The power delivered by V¬G was also experimentally measured where it is observed that the measured power turns out to be at the same level of the noise floor of the measurement which is ˜8 orders of magnitude smaller than the generated electrical power.

FIG. 6d shows the comparison between the electrical power consumption for different types of neurons found in literature. There are mainly three other approaches to making an artificial spiking neuron: (1) Metal-insulator transition (MIT) memristors and a capacitor, (2) circuit-based techniques implemented with CMOS technology and (3) ferroelectric FETs (FeFET) with a regular FET. While the MIT neurons can be scaled down to ˜1000 nm², the minimum power cost is ˜30 ρW and energy cost is ˜50 pJ for oscillation which are significantly larger compared to that of biological neurons^{6,12-15,17,18,22,67} CMOS based neurons have a large distribution of power and energy costs depending on the circuit techniques used for implementing the spiking neural behavior^{34,68-73}. Current state-of-the-art spiking neuron⁷⁰ has a 35 μm² area with a 100 pW electrical power consumption whereas a typical biological neuron of ˜10 μm² area has a power consumption of ˜1 nW. FeFET neurons also demonstrate promise in achieving oscillation with power densities similar to those of biological neurons. In contrast to all these neuron technologies, the neuron theoretically requires a zero external electrical power to generate spiking behavior. However, since measurement noise floor limits the smallest measurable power, the electrical power consumption was calculated to be ˜0.5 pW as shown in FIG. 6d. It is important to note that, this value of 0.5 pW reflects the upper limit to the measurable external electrical power consumption while the actual value is expected to be zero. It is noteworthy that there has been a demonstration of an artificial spiking afferent nerve that takes pressure applied at a piezoelectric sensor as input and the generated piezoelectric voltage can drive the spiking oscillations without external electric power⁵⁶. However, piezoelectric sensors cannot sustain a static voltage as the transduced electric charges leak away with time and therefore the spiking oscillations do not sustain this zero electrical power operation beyond a transient time.

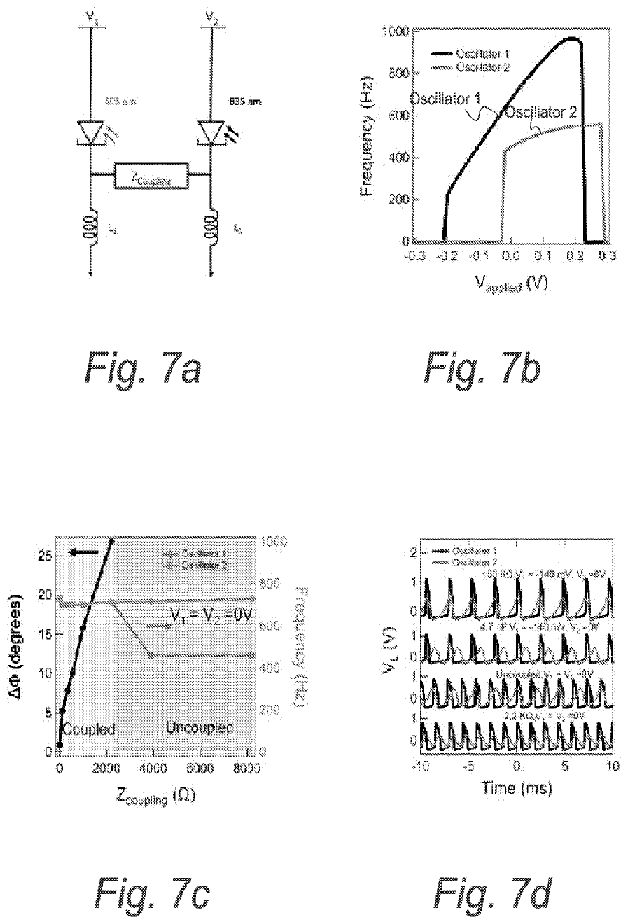

Since the performance of the individual neurons here is promising, experiments to demonstrate the behavior of a system of coupled neurons were also conducted. Hence, the collective behavior of the neurons was explored by coupling two neurons with a coupling impedance, Zcoupling as shown in FIG. 7a. The two oscillators have significantly different oscillation amplitudes and frequencies when they are uncoupled as shown in FIG. 7b. When the neurons are coupled to each other with VGr−Si=0 V for both neurons, the frequencies will synchronize when Zcoupling is below a critical value. As shown in FIG. 7c, when Z_{coupling} is smaller than 2 KΩ, the neurons will lock in both frequency and phase difference. As Z_{coupling} increases, the phase difference increases, and when Z_{coupling} becomes >2 kΩ, the coupling is completely lost, and the neurons oscillating at their individual free running frequencies.

Furthermore, the impedance values over which the two oscillators can be coupled may be increased by operating the individual oscillators at different VGr−Si values to match their free-running frequencies more closely. As shown in FIG. 7b, is possible to match these neurons in frequency if neuron 1 is operated at negative voltages (V₁<0V) while keeping neuron 1 at V₂=0V. From FIG. 7d, it can be seen that when V₁=−140 mV, both neurons match in frequency and they can maintain a small and constant phase difference for a Z_{coupling}=150 KΩ (resistive) and Zcoupling=70 KΩ (capacitive, 4.7 nF) which are much larger than Z_{coupling} (<2 KΩ) at which they could couple when they had a much different individual frequency.

The numerical model of individual neurons was extended to resistively coupled neurons. The two neurons will share a common current path through the coupling resistance, R_{coupling} (=Z_{coupling} in this case) and this shared current (i_{coupling}=(V_{1,1}−V_{1,2})/R_{coupling}) will help them synchronize their oscillation frequency and phase. The I-V curves were taken from the experimental coupled oscillation measurement as well as the corresponding inductance values (200 and 100 mH) and then simulated for different values of R_{coupling}. For smaller R_{coupling} (<2kΩ), the oscillators can match each other in frequency and phase even though they have different free running frequencies when uncoupled. For larger R_{coupling} (>2kΩ), the oscillators cannot share large enough current between each other to match their frequencies and consequently lose the synchronization. The simulation results show zero phase difference throughout the synchronized operation regime whereas experimental results show a non-zero constant phase difference as well. This discrepancy is due to the parasitic coupling capacitance between the oscillators in real system that has not been considered in the simulation. However, the simulations accurately estimate the range of R_{coupling} (<2 kΩ) within which the neurons can show coupling behavior when compared to the experimental results. The experimental results further showed that a smaller frequency difference can allow larger values of R_{coupling} and still get coupled to each other. In order to check the extent of this result, the oscillator was coupled to another identical oscillator. Then the inductance of the second oscillator was varied so that its free running frequency can also be varied. This system was then simulated for different R_{coupling} values. A colormap of the frequency difference between two oscillators as a function of inductance of the second oscillator (L₂) and R_{coupling} shows that the oscillators can match each other in frequency at very large R_{coupling} values when L₂≈L₁=200 mH, i.e., the difference in free running frequency of two oscillators is small. For other values of L₂, the coupling is lost when R_{coupling} increases. From these measurements and simulations, it is evident that the neurons can couple with each other through a coupling impedance and this coupling impedance maintains an inverse relationship with the difference in the free-running frequencies of the oscillators.

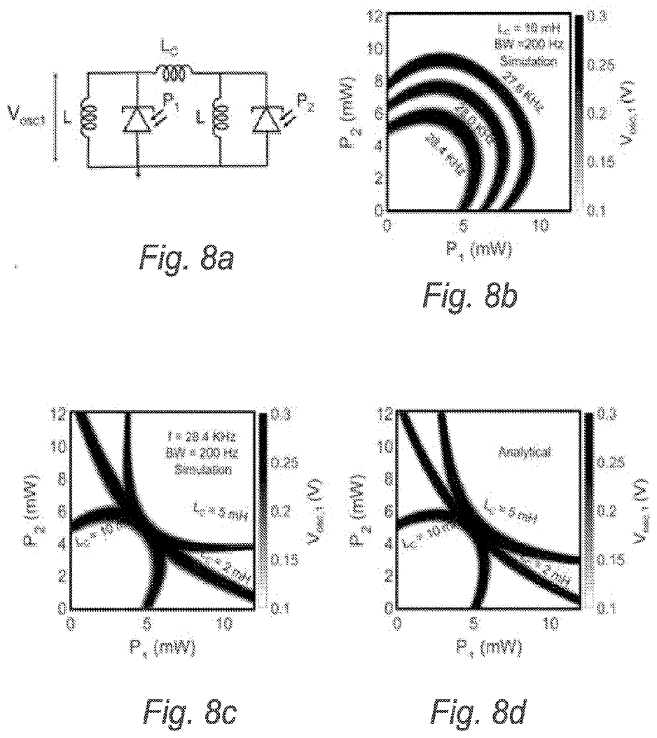

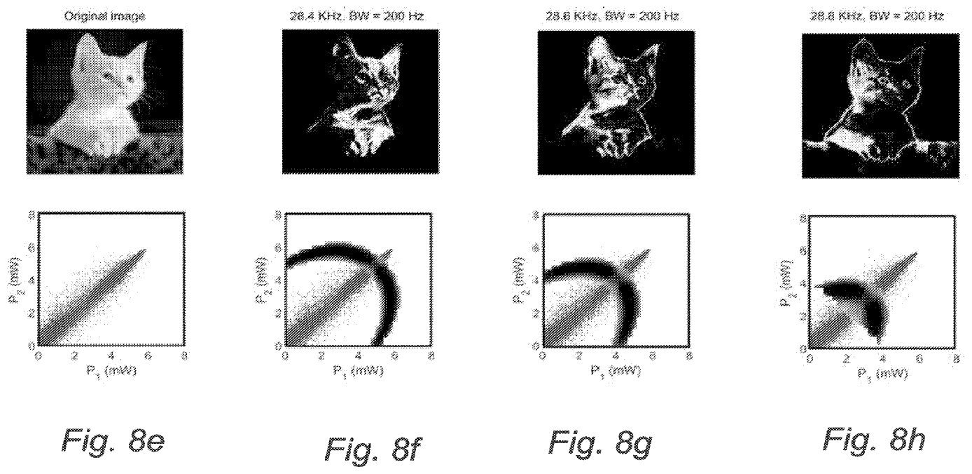

Next, a simple demonstration of how these coupled oscillators conduct computation is demonstrated. ORN circuits connected to bandpass filters were simulated to elucidate the behavior of coupled ORNs and how image processing occurs. An ORN comprising a photodetector with an active area of 1 mm² connected to an external inductor (L=10 mH) with V_{applied}=0V was considered. The V-t curves of the ORN were simulated using the experimental photodetector capacitance and J-V values. The V-t output of the simulation is filtered with varying center frequencies (f) and bandwidths (BW) representing different bandpass filters. It is shown that each bandpass filtered output of a single ORN can be analytically approximated with Lorentzians. FIG. 8a shows the schematic of two ORNs with inductive coupling, L_{c}=10 mH. FIG. 8b plots the bandpass filtered V_{osc1} magnitude as a function of P₁ and P₂ for varying center frequencies f=28.4, 28, and 27.6 kHz with BW=200 Hz. The results show that two coupled oscillators define a curved subspace of the input. FIG. 8c shows the simulation results for a fixed filter with f=28.4 kHz and BW=200 Hz and varying coupling impedance. This results in subspaces of varying shapes. While accurate solutions of the oscillator-coupled non-linear differential equations require numerical solutions, the subspace can be analytically approximated by reducing the two oscillator problem to a single oscillator problem by introducing a new quantity

$${P}_{12} = \sqrt{{P}_{1}^{2} + {P}_{2}^{2} + a ( {P}_{1} + {P}_{2} ) + k {P}_{1} {P}_{2} + b}$$

which nonlinearly combines P₁ and P₂. The coupled oscillator result then becomes

$${V}_{o s c} ( {P}_{12} , f , BW ) = \frac{γ}{{( {P}_{12} - {P}_{00} )}^{2} + {( Δ P )}^{2}} ,$$

which can be fit to approximate the result from FIG. 8c as shown in FIG. 8d. Here, P₀₀ is a function of the center frequency f and ΔP is a function of the filter bandwidth, BW.

To obtain a visual representation of how an image is processed in this scheme, the 2-ORN circuit was treated as a 1×2 convolutional kernel and processed a grayscale image of a cat (FIG. 2e, top panel) with 250×240 pixels. The bottom panel of FIG. 8e shows the (P₁, P₂) pixel pairs, which serve as inputs to the 1×2 convolution kernel. The top panels in FIGS. 8f-h show the filtered output images for f=28.4, 28.6 and 28.8 kHz and BW=200 Hz. Clearly, the original image has been mapped to multiple processed images, indexed by the filter's center frequency. The bottom panels of FIGS. 8f-h show how the subspaces, defined by the ORN coupling, filter center frequency (f), and bandwidth (BW), overlap with the (P₁, P₂) pixel pairs of the original image. The coupled ORNs select the subset of the pixels that overlap with the defined subspace. These results on a toy problem visually show how non-linear computations are performed using coupled ORN oscillators.

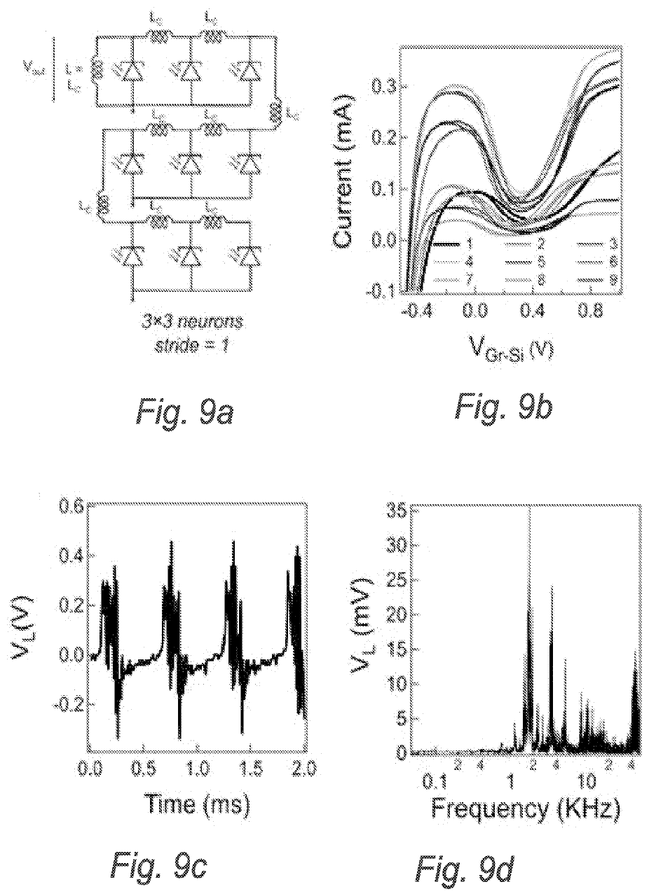

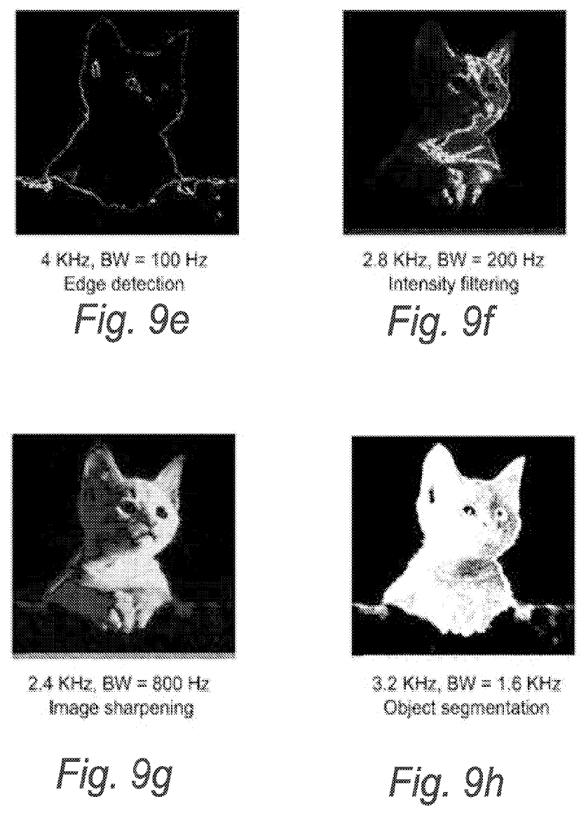

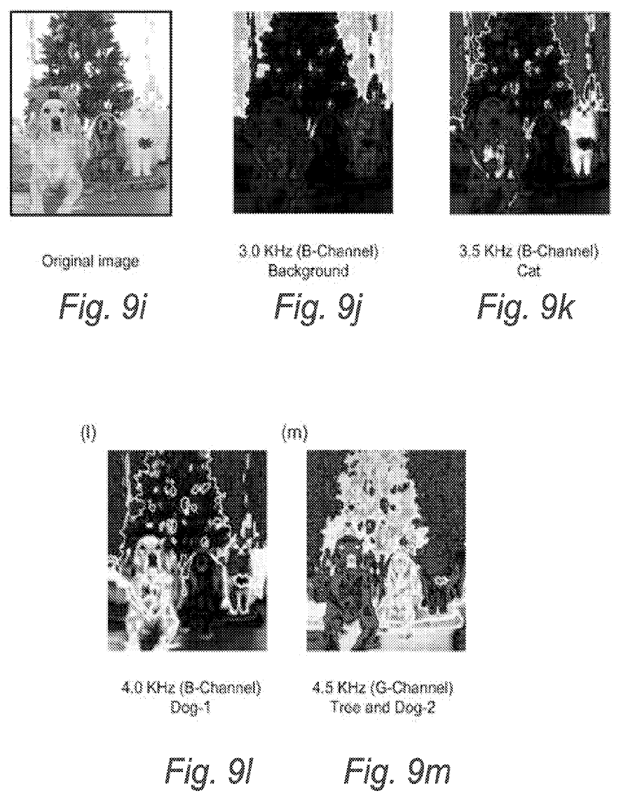

To experimentally demonstrate how coupled ORNs conduct more useful and complex image processing functions, from edge detection to image sharpening, a 3×3 ORN focal plane array with a cascaded connection was experimentally fabricated, as shown in FIG. 9a. This is used as a kernel that slides across an image in the same manner as a convolution operation in a convolutional neural network (CNN). A digital projector and external lens form the desired 3×3 segment of an image on the ORN focal plane array. An oscilloscope measures the output V-t signal from a single node of the array, marked by Vₒᵤₜ in FIG. 9a. The output spectrum is then processed in software to obtain the FFT and filtered outputs. FIG. 9b shows the I-V curves of all the SGM photodetectors in the experimental array under the same optical intensity (3 mW/mm²). FIG. 9c shows a representative V-t curve obtained from the 3×3 array when all the pixels are illuminated with uniform intensity. FIG. 9d shows the frequency spectrum of the V-t curve of FIG. 9c.

Referring to FIG. 2e, the digital grayscale image of a cat was taken and projected on the 3×3 ORN focal plane array, using the array as a convolution kernel with a stride of one (pixel intensity of 1 refers to 5.5 mW incident optical power). FIGS. 9e-h show the images obtained at 4 kHz (BW=100 Hz), 2.8 kHz (BW=200 Hz), 2.4 kHz (BW=800 Hz), and 3.2 kHz (BW=1.6 kHz), respectively. These filtered images demonstrate edge detection, intensity filtering, image sharpening and object segmentation operations. The circuit topology of this ORN kernel performs a multi-thresholding operation where the nonlinearly averaged intensity (P̅) of the 3×3 pixels cell is mapped to a high value if P_{low}<P̅<P_{high} and to a low value if P̅<P_{low} or P̅>P_{high} where P_{low} and P_{high} changes with center frequency and bandwidth. As the bandwidth increases, |P_{high}−P_{low}| becomes larger and can cover a larger range of pixel intensities. Therefore, at different frequencies, the ORN kernel thresholds the image within different pixel intensity ranges and the images shown in FIG. 9e-h result from these different non-linear operations. As the bandwidth was increased from FIG. 9e to 3h, a larger image region thresholded to bright pixels was observed. In this way, smaller bandwidth filters enable lower-level feature extraction, such as edges, while high bandwidth filters lead to higher level feature extraction, such as object segmentation. When the incident optical power range is lower, similar image processing can be obtained at higher center frequencies. This result shows that the choice of optical power range is not very critical if appropriate center frequencies are chosen.

Next, it was investigated whether the same 3×3 ORN focal plane array can perform image segmentation from an image with multiple objects. A color image of size 180×156 pixels (FIG. 9i) that features a Christmas tree, two dogs and a cat was selected. The image is split into three different grayscale images according to the pixel intensities of the color channels (R-channel, G-channel, and B-channel). Only pixels of the same color were coupled together. Therefore, each bandpass filter used had three different output images, one for each color channel. FIG. 9j-m shows the images filtered at 3.0 kHz (B-channel), 3.5 kHz (B-channel), 4.0 kHz (B-channel), and 4.5 kHz (G-channel), respectively. The bandwidth used for each center frequency is 1 kHz. At 3.0 kHz (B-channel), the bright background emerges as white and rest of the image is thresholded to black, effectively segmenting the background. The images filtered at 3.5 kHz (B-channel) and 4 kHz (B-channel) segment the dog on the left and the cat, respectively. On the other hand, when filtered at 4.5 kHz (G-channel), the tree and the dog in the middle are detected. It is important to note that only a single bandpass filter was used to segment an entire object in this case. Improved segmentation quality is expected when a linear combination of multiple frequencies is used. These results clearly illustrate how the ORN kernel can perform parallel, frequency multiplexed image processing and segmentation tasks.

These results show us two essential properties of this architecture: (1) the absence of any encoding or preprocessing for input, and (2) the ability to perform parallel computation at different frequencies. Since the projection of image and data acquisition are both performed in analog domain, inevitably noise is added to both the input and output of the system but can still obtain excellent results. It is also important to note that the circuit configuration used here to couple the oscillators is not unique. Engineering the circuit configurations allows the implementation of a variety of image processing functions.

Inspired by the results set forth above, multiple neurons were resistively coupled in the numerical model to construct a liquid state machine (LSM). An LSM is a form of reservoir computing that uses a large number of randomly interconnected spiking neurons which form the reservoir for computation called the “liquid.” This random interconnection between the neurons in the liquid enables them to take time-varying inputs and convert them into a spatiotemporal pattern as dictated by the firing of the neurons. This spatiotemporal pattern is a higher dimensional representation of the input data that can mathematically unwind the complexity of the input. The output from this liquid layer is called the liquid state which can then be “read out” by a very simple form of neural networks. The LSM architecture closely approximates the biological neural network where the neurons themselves are not hardcoded to perform a specific task. For example, the retinal ganglion cells are coupled together much like the way the neurons in the LSM are coupled and they process the input information collectively and send this information to the brain where this information can be used by many parallel “readout” structures to extract different features. Another important similarity between the assembly of retinal ganglion cells and LSM is that the interconnections are supervised in a manner to extract certain features. One important requirement of the hardware implementation of LSM is to be able to convert analog sensory data into time varying oscillating signals that the spiking neurons in the liquid layer can accept. Since the neurons have the ability to convert analog input (optical power density) into spiking patterns, they are suitable for implementing an LSM. A simulation of handwritten digit recognition from the MNIST database was performed with such an LSM constructed by the neurons.

Unlike the typical LSM where a separate spike autoencoder is used to perform an analog-to-spike conversion, an input layer of neurons was constructed that will directly take the analog input (intensity of the pixel) where each pixel will be attributed to a single neuron. The neurons are then interconnected with random valued resistances in the nearest neighbor fashion. This way, the input neurons themselves construct the liquid layer and there is no need to have separate spike autoencoding input layer and the liquid layer.

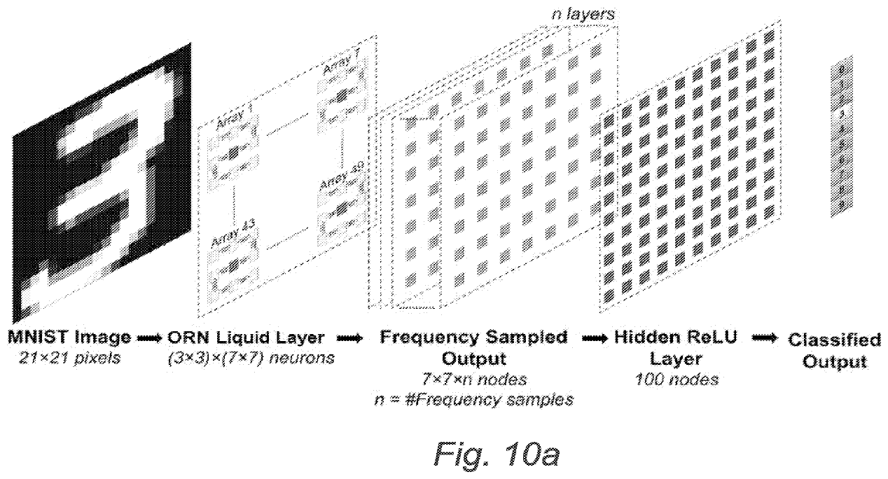

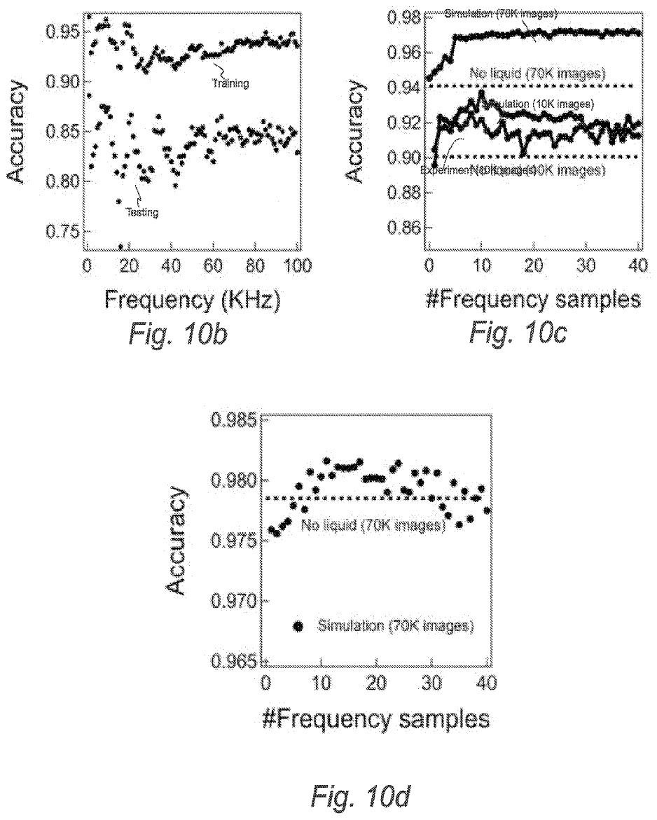

Inference is conducted by using a 3×3 pixel coupled oscillator network to function as a liquid layer to construct a liquid state machine (LSM). Images from the MNIST database scaled to 21×21 pixels were serially projected on the 3×3 array with a stride of 3, while output signals were acquired from a single pixel. This data acquisition mode converts 21×21 images into 7×7×n datapoints where n is the number of frequency samples considered. Each frequency sample corresponds to a bandpass filtered output at a given center frequency and a bandwidth of 1 KHz. Ten thousand images from the MNIST database were projected on the array, and the output data was collected and fed into a readout layer consisting of a single hidden layer with 100 nodes followed by a 10-node output layer. The hidden layer used a ReLU activation function, and the output layer used a SoftMax activation function. Backpropagation was used to train only the readout layer while keeping the liquid layer connections untouched. FIG. 10a shows the LSM schematic. FIG. 10b plots the accuracy obtained at the 50^{th} epoch if only a single frequency from each coupled array is fed into the hidden layer.

As expected, the single-frequency results show that the resulting accuracy varies by filter frequency. Feeding multiple frequency samples per pixel to the hidden layer is expected to augment the accuracy of the network. FIG. 10c shows how feeding multiple frequencies into the hidden network modifies the testing accuracies obtained at the 200^{th} epoch. This was performed for both experimental and simulated ORN arrays. The experiments were conducted on 10,000 images, limited by the speed of the data acquisition and projection setup. It was observed a peak accuracy of 92.51% with 7 frequencies sampled per pixel. To evaluate the potential of this result if the full dataset of 70,000 images were used, a simulated version of the same 3×3 ORN focal plane array was also conducted. It can be seen that the resulting accuracy for the experimental and simulation cases with 10,000 images are very similar. As the simulation uses the experimental device I-V curves, discrepancies between the simulation and experiment are attributed to the additional noise introduced by the image projection and data collection setup. The in-sensor processed image performs better than the equivalent 7×7 input directly fed to the hidden layer without the liquid layer, which results in 90.06% accuracy. Similarly, through simulation, it was observed that for all 70,000 images the accuracy reaches 97.21% with multiple frequencies, which is higher than the corresponding direct 7×7 data input (94.11%) into the neural network. Critically, if the 3×3 array is used as a convolution kernel with a stride of 1, a peak accuracy of 98.16% is achieved for 11 frequency samples per pixel, as shown in FIG. 10d. This is higher than a standard imager directly inputting the 21×21 data (97.85%) into the neural network, showing improvement using this hardware over a purely software-defined approach. These results show that the parallel processing performed at different frequencies improves the network and that the coupling between pixels in the 3×3 array allows down-sampling of the number of outputs to the hidden layers of the fully connected neural network. In addition, the LSM architecture does not require the training of liquid layer interconnections, which significantly reduces the complexity and computational cost of the training.

While an ORN array does not require any external electrical power to drive the oscillations, the system requires peripheral circuitry to read the voltages and perform bandpass filtering operations. A charge domain on-chip FFT processor⁵⁵ can perform such operations with a low energy cost. Advantageously, n ORN array can perform convolution equivalent tasks with a performance of 42211 TOPS/W, which translates to an energy cost of 24 aJ/OP with a precision equivalent to 8-bit integer operations in digital systems. These projections clearly show that frequency multiplexed computing using coupled ORN array has the potential to completely replace the energy-expensive convolutional layers in CNN for deep learning applications.

TABLE 1
Comparison between different NPUs

| | | | | | Normalized |
|---|---|---|---|---|---|
| NPU | | | | Reported | TOPS/W (8 |
| application | Type | Comment | bits | TOPS/W | bits) |
| Analog to | Analog | In-sensor NN | 8 | 43.5 | 43.5 |
| information | | | | | |
| conversion¹ | | | | | |
| VMM² | Digital | SRAM | 4 | 351 | 87.75 |
| MAC | Analog | DRAM | 4 | 217 | 54.25 |
| macro¹⁶ | | | | | |
| VMM²³ | Digital | DNN learning | 8 | 146.52 | 146.52 |
| | | processor | | | |
| Arithmetic | Digital | Supercon- | 8 | 120 | 120 |
| logic³¹ | | ducting logic | | | |
| | | devices | | | |
| VMM³² | Analog | Si- | 6 | 210 | 118.13 |
| | | CMOS/CAAC- | | | |
| | | IGZO based | | | |
| | | memory | | | |
| VMM⁴⁰ | Digital | Stochastic NN | 8 | 75 | 75 |
| | | accelerator | | | |
| MAC | Digital | SRAM | 8 | 63 | 63 |
| macro⁵² | | | | | |
| MAC | Analog | SONOS | 8 | 100 | 100 |
| macro⁵³ | | memory | | | |
| MAC | Digital | SRAM | 1 | 20943 | 327.23 |
| macro⁵⁴ | | | | | |
| General | Digital | NVIDIA A100 | 8 | 4.992 | 4.992 |
| purpose | | | | | |
| General | Digital | Apple a16 | 8 | 2.67 | 2.67 |
| purpose | | Bionic | | | |
| General | Digital | Qualcomm | 8 | 4.5 | 4.5 |
| purpose | | Snapdragon | | | |
| | | 865 | | | |
| Nonlinear | Analog | ORN | 8 | 42211 | 42211 |
| convolution | | | | | |
| (3 × 3 | | | | | |
| kernel) | | | | | |
| (This work) | | | | | |

Table 1 shows the performance comparison between different neural processing units (NPU) for deep learning. Different NPUs operate at different bit resolutions and therefore an n-bit performance was scaled by a factor of

$${( \frac{n}{8} )}^{2}$$

to get a normalized 8-bit performance. Such a scaling is reasonable^{56,57} since number of transistors in digital logic typically scales as ˜n².

In conclusion, it has been shown that a simple SGM photodetector can demonstrate NDR behavior that can be translated into spiking patterns analogous to the behavior of biological retina when connected to a single MOSFET based active inductor. Therefore, the challenge of scaling the inductor as well as experimentally demonstrated neuronal activity has been tackled without any electrical power consumption by just transducing the sensory optical power input. The mechanism of oscillation through a numerical model using experimental data is explained and the model extended to resistively couple multiple neurons. Using this numerical model, an LSM has been made that features randomly interconnected neurons as the liquid of the machine and a single layer readout that can accurately classify the MNIST handwritten digits processed by the liquid. In addition, a network of neurons was constructed that can perform as a convolution kernel for detecting edges from images of the BSDS300 database. While the focus was on image classification and edge detection applications, applications can be extended to other problems in computer vision such as motion detection, motion tracking etc. This experiment described above provide a roadmap to designing and implementing a new class of neurons through the optically activated NDR device, replacing the real inductor with the MOSFET based inductor, generation of spiking oscillations without any external electrical power and finally the demonstration of the neural networks for different computational tasks.

### Methods

Semiconductor substrate preparation. Moderately boron doped (Na=5×10⁵ cm⁻³) silicon (100) wafer (University Wafer) was used as the semiconductor substrate. A 5 nm Ti/60 nm Au mesh is photolithographically defined and deposited by electron beam evaporation. A monolayer of CVD grown graphene is transferred on top of the metal mesh via wet transfer method⁶¹. A 100 nm aluminum film sputtered at the back side of the substrate acts as the contact to silicon.

Graphene growth and transfer. CVD graphene was grown on a Cu foil by using low pressure CVD. Cu foil was etched inside FeCl₃ copper etchant for 30 seconds before the graphene growth. Cu foil was annealed in a quartz tube furnace at 1000° C. for 30 min with 50 standard cubic centimeters per minute (sccm) flow rate of hydrogen (H₂). Synthesize of graphene processed under 7 sccm of methane (CH₄) and 50 sccm of hydrogen (H₂) for 40 min. On purpose of transfer, Poly(methyl methacrylate) (PMMA A6495) was spin coated on top of Cu foil at 2000 rpm for 60 see and baked for 5 min under 170° C. PMMA spin coated Cu foil was etched by using FeCl₃ copper etchant graphene to remove the Cu while remaining PMMA/Graphene floating layer. The stacked layer was cleaned with D.I water and transferred to 10% hydrochloric acid solution to remove the remaining Cu etchants. After cleaning with D.I water again, PMMA/Graphene was transferred on top of the oxide/semiconductor substrate. The substrate was dried in the air overnight and following 90° C. for 15 min, 150° C. for 30 min, and 90° C. for 15 min steps to ensure the adhesion between the graphene and the substrate. PMMA was dissolved in acetone overnight.

Raman spectroscopy for graphene. CVD grown monolayer graphene transferred on top of the substrate was analyzed by Raman spectroscopy. Raman spectra are collected by using a Renishaw spectrometer with a 532-nm laser-focused in a 0.5-μm spot through a Leica microscope with a 100× objective lens.

Wavelength dependent measurements. A supercontinuum laser with grating monochromator was used to illuminate the SGM photodetector with lights of different wavelengths between 400 and 1100 nm. Applied voltage was stepped while light and dark current measurements were performed. The difference between these two current measurements, i.e., the photocurrent was then used to measure the responsivity of the device.

ORN measurements. A 5×5 array of SGM photodetectors was fabricated and individual devices were wire bonded to a PCB. The devices were electrically connected to the inductors (all 10 mH) on a breadboard to form the ORN kernel. A digital projector was used to project the patterns on the device array (a 3×3 array from the 5×5 array) and an oscilloscope was used to record the oscillation waveforms. The whole process was automated using MATLAB environment.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

### REFERENCES

1 Benjamin, B. V. et al. Neurogrid: A Mixed-Analog-Digital Multichip System for Large-Scale Neural Simulations. Proceedings of the IEEE 102, 699-716, doi:10.1109/JPROC.2014.2313565 (2014).
2 Liu, S. C. & Delbruck, T. Introduction to Neuromorphic and Bio-Inspired Mixed-Signal VLSI. Pasadena, CA: California Institute of Technology [Google Scholar](2007).
3 Attwell, D. & Laughlin, S. B. An Energy Budget for Signaling in the Grey Matter of the Brain. Journal of Cerebral Blood Flow & Metabolism 21, 1133-1145, doi:10.1097/00004647-200110000-00001(2001).
4 Lennie, P. The Cost of Cortical Computation. Current Biology 13, 493-497, doi:https://doi.org/10.1016/S0960-9822(03)00135-0 (2003).
5 Oliveira, A. The digital mind: How science is redefining humanity. (MIT Press, 2017).
6 Poon, C.-S. & Zhou, K. Neuromorphic silicon neurons and large-scale neural networks: challenges and opportunities. Frontiers in neuroscience 5, 108 (2011).
7 Esaki, L. New Phenomenon in Narrow Germanium $pensuremath{-}n$ Junctions. Physical Review 109, 603-604, doi:10.1103/PhysRev.109.603 (1958).
8 Gunn, J. B. Microwave oscillations of current in III-V semiconductors. Solid State Communications 1, 88-91, doi:https://doi.org/10.1016/0038-1098(63)90041-3 (1963).
9 Nagumo, J., Arimoto, S. & Yoshizawa, S. An active pulse transmission line simulating nerve axon. Proceedings of the IRE 50, 2061-2070 (1962).
10 NISHIZAWA, J.-I. & HAYASAKA, A. Two-line neuristor with active element in series and in parallel. INTERNATIONAL JOURNAL OF ELECTRONICS 26, 437-469 (1969).
11 Crane, H. 30-31 (IEEE).
12 Duan, Q. et al. Spiking neurons with spatiotemporal dynamics and gain modulation for monolithically integrated memristive neural networks. Nature communications 11, 1-13 (2020).
13 Wang, Z. et al. Fully memristive neural networks for pattern classification with unsupervised learning. Nature Electronics 1, 137-145 (2018).
14 Jerry, M., Parihar, A., Grisafe, B., Raychowdhury, A. & Datta, S. T186-T187 (IEEE).
15 Tuma, T., Pantazi, A., Le Gallo, M., Sebastian, A. & Eleftheriou, E. Stochastic phase-change neurons. Nature nanotechnology 11, 693-699 (2016).
16 Lim, H. et al. Relaxation oscillator-realized artificial electronic neurons, their responses, and noise. Nanoscale 8, 9629-9640 (2016).
17 Lee, D. et al. Various threshold switching devices for integrate and fire neuron applications. Advanced Electronic Materials 5, 1800866 (2019).
18 Pickett, M. D., Medeiros-Ribeiro, G. & Williams, R. S. A scalable neuristor built with Mott memristors. Nature materials 12, 114-117 (2013).
19 Stoliar, P. et al. A leaky-integrate-and-fire neuron analog realized with a Mott insulator. Advanced Functional Materials 27, 1604740 (2017).
20 Mehonic, A. & Kenyon, A. J. Emulating the electrical activity of the neuron using a silicon oxide RRAM cell. Frontiers in neuroscience 10, 57 (2016).
21 Gupta, I. et al. Real-time encoding and compression of neuronal spikes by metal-oxide memristors. Nature communications 7, 1-9 (2016).
22 Huang, H. M. et al. Quasi-Hodgkin-Huxley Neurons with Leaky Integrate-and-Fire Functions Physically Realized with Memristive Devices. Advanced Materials 31, 1803849 (2019).
23 Ignatov, M., Ziegler, M., Hansen, M., Petraru, A. & Kohlstedt, H. A memristive spiking neuron with firing rate coding. Frontiers in neuroscience 9, 376 (2015).
24 Hess, K., Morkog, H., Shichijo, H. & Streetman, B. G. Negative differential resistance through real-space electron transfer. Applied Physics Letters 35, 469-471, doi:10.1063/1.91172 (1979).
25 Ho, C.-L., Wu, M.-C., Ho, W.-J. & Liaw, J.-W. Light-induced negative differential resistance in planar InP/InGaAs/InP double-heterojunction p-i-n photodiode. Applied Physics Letters 74, 4008-4010, doi:10.1063/1.123243 (1999).
26 Vega-Gonzaĺez, V., Gutiérrez-Dominguez, E. & Guarin, F. in 2013 Proceedings of the European Solid-State Device Research Conference (ESSDERC). 330-333.
27 Sharma, P., Bernard, L. S., Bazigos, A., Magrez, A. & Ionescu, A. M. Room-Temperature Negative Differential Resistance in Graphene Field Effect Transistors: Experiments and Theory. ACS Nano 9, 620-625, doi:10.1021/nn5059437 (2015).
28 Wu, Y. et al. Three-Terminal Graphene Negative Differential Resistance Devices. ACS Nano 6, 2610-2616, doi:10.1021/nn205106z (2012).
29 Chen, H., Nie, H. & Guo, L. Interface trap-induced negative differential resistance in nMOSFET with floating source. Physics Letters A 384, 126342, doi:https://doi.org/10.1016/j.physleta.2020.126342 (2020).
30 Hourdakis, E., Kaidatzis, A., Niarchos, D. & Nassiopoulou, A. G. Voltage-controlled negative differential resistance in metal-sputtered alumina-Si structures. Journal of Physics D: Applied Physics 52, 085101, doi:10.1088/1361-6463/aaf499 (2018).
31 Liu, W. et al. Light-induced negative differential resistance in gate-controlled graphene-silicon photodiode. Applied Physics Letters 112, 201109, doi:10.1063/1.5026382 (2018).
32 Wang, X. et al. Light-induced negative differential resistance effect in a resistive switching memory device. Current Applied Physics 20, 371-378, doi:https://doi.org/10.1016/j.cap.2019.12.008 (2020).
33 Chen, J., Reed, M. A., Rawlett, A. M. & Tour, J. M. Large On-Off Ratios and Negative Differential Resistance in a Molecular Electronic Device. Science 286, 1550-1552, doi:10.1126/science.286.5444.1550 (1999).
34 Zhao, F. et al. Silicon neuron transistor based on CMOS negative differential resistance (NDR). IEICE Electronics Express 17, 20200316-20200316, doi:10.1587/elex.17.20200316 (2020).
35 Amir, M. et al. in 2016 IEEE SOI-3D-Subthreshold Microelectronics Technology Unified Conference (S3S). 1-2 (IEEE).
36 Amir, M. F., Ko, J. H., Na, T., Kim, D. & Mukhopadhyay, S. 3-D stacked image sensor with deep neural network computation. IEEE Sensors Journal 18, 4187-4199 (2018).
37 Choo, K. D. et al. Energy-efficient motion-triggered IoT CMOS image sensor with capacitor array-assisted charge-injection SAR ADC. IEEE Journal of Solid-State Circuits 54, 2921-2931 (2019).
38 Du, Z. et al. in Proceedings of the 42nd Annual International Symposium on Computer Architecture. 92-104.
39 Finateu, T. et al. in 2020 IEEE International Solid-State Circuits Conference-(ISSCC). 112-114 (IEEE).
40 Hsu, T.-H. et al. in 2019 IEEE International Electron Devices Meeting (IEDM). 22.25. 21-22.25. 24 (IEEE).
41 Hsu, T.-H. et al. A 0.8 V multimode vision sensor for motion and saliency detection with ping-pong PWM pixel. IEEE Journal of Solid-State Circuits 56, 2516-2524 (2021).
42 Jiménez-Fernández, A. et al. A binaural neuromorphic auditory sensor for FPGA: A spike signal processing approach. IEEE transactions on neural networks and learning systems 28, 804-818 (2016).
43 Lichtsteiner, P., Posch, C. & Delbruck, T. A 128$times $128 120 dB 15$mu $ s latency asynchronous temporal contrast vision sensor. IEEE journal of solid-state circuits 43, 566-576 (2008).
44 LiKamWa, R., Hou, Y., Gao, J., Polansky, M. & Zhong, L. Redeye: analog convnet image sensor architecture for continuous mobile vision. ACM SIGARCH Computer Architecture News 44, 255-266 (2016).
45 Wang, C.-Y. et al. Gate-tunable van der Waals heterostructure for reconfigurable neural network vision sensor. Science Advances 6, eaba6173 (2020).
46 Zhou, F. & Chai, Y. Near-sensor and in-sensor computing. Nature Electronics 3, 664-671 (2020).
47 Mennel, L. et al. Ultrafast machine vision with 2D material neural network image sensors. Nature 579, 62-66 (2020).
48 Lyon, R. F. & Mead, C. An analog electronic cochlea. IEEE Transactions on Acoustics, Speech, and Signal Processing 36, 1119-1134 (1988).
49 Hasler, P., Smith, P. D., Graham, D., Ellis, R. & Anderson, D. V. Analog floating-gate, on-chip auditory sensing system interfaces. IEEE Sensors Journal 5, 1027-1034 (2005).
50 Hsieh, H.-Y. & Tang, K.-T. VLSI implementation of a bio-inspired olfactory spiking neural network. IEEE transactions on neural networks and learning systems 23, 1065-1073 (2012).
51 Wen, B. & Boahen, K. in 2006 IEEE International Solid State Circuits Conference-Digest of Technical Papers. 2268-2277 (IEEE).
52 Ellis, R., Yoo, H., Graham, D. W., Hasler, P. & Anderson, D. V. in 2002 IEEE International Symposium on Circuits and Systems. Proceedings (Cat. No. 02CH37353). II-II (IEEE).
53 Schrauwen, B., D'Haene, M., Verstraeten, D. & Van Campenhout, J. 1097-1102 (IEEE).
54 Tan, H. et al. Tactile sensory coding and learning with bio-inspired optoelectronic spiking afferent nerves. Nature communications 11, 1-9 (2020).
55 Kim, Y. et al. A bioinspired flexible organic artificial afferent nerve. Science 360, 998-1003 (2018).
56 Zhang, X. et al. An artificial spiking afferent nerve based on Mott memristors for neurorobotics. Nature communications 11, 1-9 (2020).
57 Zhou, F. et al. Optoelectronic resistive random access memory for neuromorphic vision sensors. Nature nanotechnology 14, 776-782 (2019).
58 Maass, W., Natschläger, T. & Markram, H. Real-time computing without stable states: A new framework for neural computation based on perturbations. Neural computation 14, 2531-2560 (2002).
59 Maass, W. On the Computational Power of Recurrent Circuits of Spiking Neuron. Technische Universität Graz (2000).
60 Yamazaki, T. & Tanaka, S. The cerebellum as a liquid state machine. Neural Networks 20, 290-297 (2007).
61 Rezaeifar, F., Ahsan, R., Lin, Q., Chae, H. U. & Kapadia, R. Hot-electron emission processes in waveguide-integrated graphene. Nature Photonics, 1-6 (2019).
62 Wu, Y.-C. & Jhan, Y.-R. in 3D TCAD Simulation for CMOS Nanoeletronic Devices 1-17 (Springer, 2018).
63 Ahsan, R., Sakib, M. A., Chae, H. U. & Kapadia, R. Performance limits of graphene hot electron emission photoemitters. Physical Review Applied 13, 024060 (2020).
64 Chae, H. U. et al. High Quantum Efficiency Hot Electron Electrochemistry. Nano letters 19, 6227-6234 (2019).
65 Chae, H. U., Ahsan, R., Tao, J., Cronin, S. B. & Kapadia, R. Tunable Onset of Hydrogen Evolution in Graphene with Hot Electrons. Nano Letters 20, 1791-1799 (2020).
66 Chae, H. U., Ahsan, R., Tao, J., Cronin, S. B. & Kapadia, R. Increasing the Hot-Electron Driven Hydrogen Evolution Reaction Rate on a Metal-Free Graphene Electrode. Advanced Materials Interfaces 8, 2001706 (2021).
67 Al-Shedivat, M., Naous, R., Cauwenberghs, G. & Salama, K. N. Memristors empower spiking neurons with stochasticity. IEEE journal on Emerging and selected topics in circuits and systems 5, 242-253 (2015).
68 Seo, J.-s. et al. in 2011 IEEE Custom Integrated Circuits Conference (CICC). 1-4 (IEEE).
69 Indiveri, G., Chicca, E. & Douglas, R. A VLSI array of low-power spiking neurons and bistable synapses with spike-timing dependent plasticity. IEEE transactions on neural networks 17, 211-221 (2006).
70 Sourikopoulos, I. et al. A 4-fJ/Spike Artificial Neuron in 65 nm CMOS Technology. Frontiers in Neuroscience 11, doi:10.3389/fnins.2017.00123 (2017).
71 Indiveri, G. in Proceedings of the 2003 International Symposium on Circuits and Systems, 2003. ISCAS'03. IV-IV (IEEE).
72 Mahowald, M. & Douglas, R. A silicon neuron. Nature 354, 515-518, doi:10.1038/354515a0 (1991).
73 Wijekoon, J. H. & Dudek, P. Compact silicon neuron circuit with spiking and bursting behaviour. Neural Networks 21, 524-534 (2008).
74 Cotter, M. J., Fang, Y., Levitan, S. P., Chiarulli, D. M. & Narayanan, V. in 2014 IEEE Computer Society Annual Symposium on VLSI. 130-135 (IEEE).
75 Csaba, G., Raychowdhury, A., Datta, S. & Porod, W. in 2018 IEEE International Symposium on Circuits and Systems (ISCAS). 1-5 (IEEE).
76 Koo, M. et al. Distance computation based on coupled spin-torque oscillators: Application to image processing. Physical Review Applied 14, 034001 (2020).

What is claimed is:

1. A silicon-graphene-metal photodetector comprising:
a silicon substrate having a first face and a second face;
a patterned metal contact disposed over the first face of the silicon substrate to form a metal-semiconductor contact; and
a graphene sheet contacting both the silicon substrate and the patterned metal contact such that to form a graphene-semiconductor contact, wherein the silicon-graphene-metal photodetector is operatable with negative differential resistance.

2. The silicon-graphene-metal photodetector of claim 1, wherein the silicon substrate is composed of p-doped silicon.

3. The silicon-graphene-metal photodetector of claim 1, wherein the patterned metal contact is patterned as a rectangular grid.

4. The silicon-graphene-metal photodetector of claim 1, further comprising a bottom metallic contact layer disposed over the second face.

5. The silicon-graphene-metal photodetector of claim 4, wherein the silicon-graphene-metal photodetector is operated with exposure to light.

6. The silicon-graphene-metal photodetector of claim 5, a bias voltage is applied across the patterned metal contact and the bottom metallic contact layer biased at a sufficient voltage for inducing oscillations.

7. The silicon-graphene-metal photodetector of claim 6, wherein the bias voltage is from −0.5 and +0.5 volts.

8. The silicon-graphene-metal photodetector of claim 6, wherein the bias voltage is from −0.2 to 0.2 volts.

9. The silicon-graphene-metal photodetector of claim 4, wherein a bias voltage is not applied across the patterned metal contact and the bottom metallic contact layer.

10. A sensing device including a first retinal circuit comprising:
a first silicon-graphene-metal photodetector including:
a silicon substrate having a first face and a second face;
a patterned metal contact disposed over the first face of the silicon substrate to form a metal-semiconductor contact;
a graphene sheet contacting both the silicon substrate and the patterned metal contact such that to form a graphene-semiconductor contact, wherein NDR occurs during positive power generation; and
a bottom metallic contact layer disposed over the second face of the silicon substrate; and
a first inductive component in electrical communication with the first silicon-graphene-metal photodetector, wherein the first retinal circuit is operatable as an oscillator.

11. The sensing device of claim 10, wherein the silicon substrate is composed of p-doped silicon.

12. The sensing device of claim 10 further comprising a second retinal circuit electrically coupled to the first retinal circuit with an impedance component.

13. The sensing device of claim 10, wherein the first silicon-graphene-metal photodetector is operated with exposure to light.

14. The sensing device of claim 13, wherein a bias voltage is applied across the patterned metal contact and the bottom metallic contact layer biased at a sufficient voltage for inducing oscillations.

15. The sensing device of claim 14, wherein the bias voltage is from −0.5 and +0.5 volts.

16. The sensing device of claim 14, wherein the bias voltage is from −0.2 to 0.2 volts.

17. The sensing device of claim 10, wherein a bias voltage is not applied across the patterned metal contact and the bottom metallic contact layer biased.

18. The sensing device of claim 10, further comprising a second retinal circuit electrically coupled to the first retinal circuit with an impedance component.

19. The sensing device of claim 18, wherein the impedance component is a capacitor, resistor, or a MOSFET.

20. A sensing array including a plurality of retinal circuits, each retinal circuit comprising:
a silicon-graphene-metal photodetector including:
a silicon substrate having a first face and a second face;
a patterned metal contact disposed over the first face of the silicon substrate to form a metal-semiconductor contact;
a graphene sheet contacting both the silicon substrate and the patterned metal contact such that to form a graphene-semiconductor contact, wherein NDR occurs during positive power generation; and
a bottom metallic contact layer disposed over the second face of the silicon substrate; and
an inductor is electrical communication with the silicon-graphene-metal photodetector, wherein each retinal circuit is operatable as an oscillator.

21. The sensing array of claim 20, wherein the silicon substrate is composed of p-doped silicon.

22. The sensing array of claim 20, wherein for each retinal circuit, a bias voltage is applied across the patterned metal contact and the bottom metallic contact layer biased at a sufficient voltage for inducing oscillations.

23. The sensing array of claim 20, wherein retinal circuits are interconnected with reconfigurable connections between oscillators.

24. The sensing array of claim 23, wherein the retinal circuits are interconnected with transistors.

25. The sensing array of claim 23, wherein the reconfigurable connections between oscillators are configured to perform insensor computing at low power.

26. The sensing array of claim 25, wherein the reconfigurable connections between oscillators are configured to perform image processing functions.

27. The sensing array of claim 20, configured to provide input to a neural network.

28. An oscillator circuit comprising:
a sensor that exhibits negative differential resistance; and
an inductive component in electrical communication with the sensor.

29. A computing device comprising:
a plurality of kernels, each kernel comprising:
a plurality of oscillators, each oscillator including a negative differential resistance component; and
a plurality of impedance components that couple the oscillators together, wherein each oscillator is associated with a portion of an input data set; and
a readout system to read an output voltage versus time from each oscillator and perform bandpass filtering operations, the readout system being configured to simultaneously provide a plurality of features for each portion of an input data set.

30. The computing devices of claim 29, wherein the input data set is an image and each portion of the input data set is a pixel.

31. The computing devices of claim 30, wherein each oscillator is a retinal circuit.

32. The computing devices of claim 29 wherein each oscillator is a retinal circuit comprising:
a silicon-graphene-metal photodetector including:
a silicon substrate having a first face and a second face;
a patterned metal contact disposed over the first face of the silicon substrate to form a metal-semiconductor contact;
a graphene sheet contacting both the silicon substrate and the patterned metal contact such that to form a graphene-semiconductor contact, wherein NDR occurs during positive power generation; and
a bottom metallic contact layer disposed over the second face of the silicon substrate; and
a first inductive component in electrical communication with the silicon-graphene-metal photodetector, wherein the retinal circuit is operatable as an oscillator.

33. The computing device of claim 32, wherein the first inductive component is an active inductor.

34. The computing device of claim 33, wherein the readout system includes a Fourier transform circuit that outputs a frequency spectrum for each oscillator, the frequency spectrum for each oscillator being divided into a plurality of frequency bands, each frequency band providing a measurable feature.

35. The computing device of claim 33, configure to compute image edges, to compute image intensity zone, to sharpen images, and/or to perform image segmentation.

36. The computing device of claim 33, wherein the plurality of oscillators are arranged in a 2 dimensional array.

37. The computing device of claim 29, wherein the plurality of oscillators are coupled by the impedance components with nearest neighbor coupling.

38. The computing device of claim 29, wherein the plurality of kernels are coupled by the impedance components with nearest neighbor coupling.

39. A sensor system implemented in hardware comprising:
a sensing device;
a first neural network layer in electrical communication with the sensing device;
one or more additional neural network layers;
a Fast Fourier transform circuit in electrical communication with the one or more neural network layers; and
an analog-to-digital converter in electrical communication with the Fast Fourier transform circuit and configured to digitize output from Fast Fourier transform circuit, wherein the photosensitive neural block, the one or more additional neural network layers, the Fast Fourier transform circuit, and analog-to-digital converter, the sensing device comprising retinal circuit including:
a graphene-metal photodetector including:
a silicon substrate having a first face and a second face;
a patterned metal contact disposed over the first face of the silicon substrate to form a metal-semiconductor contact;
a graphene sheet contacting both the silicon substrate and the patterned metal contact such that to form a graphene-semiconductor contact, wherein NDR occurs during positive power generation; and
a bottom metallic contact layer disposed over the second face of the silicon substrate; and
an inductor is electrical communication with the silicon-graphene-metal photodetector, wherein each retinal circuit is operatable as an oscillator.

40. The sensor system of claim 39, further comprising digital logic circuitry for processing output from the analog-to-digital converter.
